(19) United States
(12) Patent Application Publication
(10) Pub. No.: US 2017/0198196 A1
(43) Pub. Date: Jul. 13, 2017

(54) METHODS FOR CONTROLLING SOURING IN ENGINEERED SYSTEMS

(71) Applicants: The Regents of the University of California, Oakland, CA (US); BP Corporation North America Inc., Houston, TX (US)

(72) Inventors: John D. COATES, Walnut Creek, CA (US); Hans CARLSON, Albany, CA (US); Anna ENGELBREKTSON, Concord, CA (US); Mark MULLAN, Berkeley, CA (US); Martin E. CARRERA, Encinitas, CA (US)

(73) Assignees: The Regents of the University of California, Oakland, CA (US); BP Corporation North America Inc., Houston, TX (US)

(21) Appl. No.: 15/316,816

(22) PCT Filed: Jun. 5, 2015
(86) PCT No.: PCT/US15/34563

§ 371 Date: Dec. 6, 2016

Related U.S. Application Data
(60) Provisional application No. 62/009,027, filed on Jun. 6, 2014.

(51) Int. Cl. C09K 8/528; E21B 36/00; E21B 41/02; C09K 8/54; E21B 37/06

(52) U.S. Cl. CPC C09K 8/528; C09K 8/54; E21B 37/06; E21B 41/02; E21B 36/00; E21B 36/001; C09K 2208/20; C09K 2208/32

(57) ABSTRACT

The present disclosure relates generally to methods for controlling souring in engineered systems, and more specifically to methods of controlling souring using chemical, physical, and combinatorial treatments of engineered systems to reduce hydrogen sulfide-associated souring in such engineered systems, such as oil reservoirs.

### CROSS-REFERENCE TO RELATED APPLICATION(S)

This application claims the benefit of U.S. Provisional Application No. 62/009,027, filed Jun. 6, 2014, which is incorporated herein by reference in its entirety.

### FIELD

The present disclosure relates generally to methods for controlling souring in engineered systems, and more specifically to methods of controlling souring using chemical, physical, and combinatorial treatments of engineered systems to reduce hydrogen sulfide-associated souring in such engineered systems, such as oil reservoirs.

### BACKGROUND

The generation of hydrogen sulfide (H₂S) results in a variety of corrosion problems. For example, sulfidogenesis results in a variety of oil recovery problems, including oil reservoir souring, contamination of crude oil, metal corrosion, and the precipitation of metal sulfides which can subsequently plug pumping wells.

Reservoir souring is characterized by significant increases in H₂S in production gas and soluble HS⁻ in production fluids, typically after initiation of secondary recovery processes involving water injection. Although several abiotic mechanisms have been proposed as the cause of reservoir souring including thermochemical sulfate (SO₄²⁻) reduction and pyrite (FeS₂) dissolution, it is now widely accepted that sulfate-reduction by dissimilatory sulfate-reducing microorganisms (SRM) is primarily responsible for sulfide production in reservoir souring as a result of water flooding (Vance and Thrasher, Petroleum Microbiology, eds B. Ollivier & M. Magot, ASM Press, 2005).

Sour service metallurgy for wells, pipelines, and pump systems carry an estimated cost premium of 2% of total project costs at project initiation but may be an order of magnitude higher if retrofitting is required (Al-Rasheedi et al., SPE Middle East Oil Show, Society of Petroleum Engineers). Sour production facilities also entail additional costs associated with prevention of operator exposure to toxic H₂S; control of oil-wet iron sulfide pads that reduce oil-water separator performance, management of iron sulfide solids that interfere with produced water cleanup and recycle, and accumulation of iron-sulfide deposits that may foul equipment and enhance equipment corrosion. In addition, revenue loss may result from limitations imposed on pumping high volumes of oil and gas with excessive H₂S concentrations through export lines to ensure system integrity (Vance and Thrasher, Petroleum Microbiology, eds B. Ollivier & M. Magot, ASM Press, 2005).

Effort has focused on mechanisms by which H₂S generation from dissimilatory sulfate-reducing metabolism can be inhibited. Significant research has focused on thermodynamic inhibition of SRM activity by the addition of nitrate to the injection waters. Thermodynamic considerations indicate that microbial nitrate reduction is energetically more favorable than Fe(III)-reduction, sulfate-reduction, or methanogenesis and should therefore occur first (Coates and Achenbach, Manual of Environmental Microbiology, eds C. J. Hurst et al., 719-727, ASM Press, 2001; and Lovely and Chapelle, Reviews of Geophysics 33, 365-381, 1995). For example the Gibbs free energy for the anaerobic degradation of toluene coupled to nitrate-reduction (ΔGₒ′=−3,554 kJmol⁻¹ toluene) is significantly higher than that coupled to sulfate-reduction (ΔGₒ′=−205 kJmol⁻¹ toluene). Thus, the addition of excess amounts of nitrate should result in the preferential utilization of this electron acceptor and the selective inhibition of sulfate-reduction.

However, thermodynamic preferential use of nitrate over sulfate is not mutually exclusive in a system unlimited for electron donors, such as in an oil reservoir where hydrocarbon reserves represent an inexhaustible supply of biodegradable carbon to active microbial communities (Coates and Achenbach, Manual of Environmental Microbiology, eds C. J. Hurst et al., 719-727, ASM Press, 2001; and Van Trump and Coates, Isme J 3, 466-476, 2009). As such, while the presence of nitrate will slow down sulfate-reduction, it will not completely inhibit sulfate metabolism. Furthermore, the results of previous studies suggest that addition of a thermodynamically more favorable electron acceptor, such as Fe(III), may not be enough to completely inhibit sulfate-reduction once an active SRM community is established (Coates et al., Environmental Science and Technology 30, 2784-2789, 1996).

Thus, there exists a need to develop an economic and efficient method for controlling souring in engineered systems, such as oil reservoirs.

### BRIEF SUMMARY

In one aspect, the present disclosure relates to a method for controlling souring including contacting an engineered system including a souring-promoting microbial community with a composition including monofluorophosphate at a concentration sufficient to inhibit souring in a unit volume of the engineered system. In some embodiments, the engineered system is an oil reservoir. In some embodiments, the composition including monofluorophosphate is an aqueous solution of a salt of monofluorophosphate. In some embodiments, the salt of monofluorophosphate is selected from the group including sodium salts, ammonium salts, potassium salts, and calcium salts of monofluorophosphate. In some embodiments that may be combined with any of the preceding embodiments, the concentration of the monofluorophosphate present in the engineered system is in the range of about 0.1 mM to about 5 mM. In some embodiments, the concentration of the monofluorophosphate present in the engineered system is about 0.8 mM. In some embodiments that may be combined with any of the preceding embodiments, the microbial community includes both sulfate-reducing microorganisms and non-sulfate-reducing microorganisms. In some embodiments, the monofluorophosphate in the engineered system does not significantly impact the general metabolism of the non-sulfate-reducing microorganisms. In some embodiments that may be combined with any of the preceding embodiments, souring in a unit volume of the engineered system is inhibited by about 50% or more as compared to a corresponding unit volume in a system not contacted with monofluorophosphate. In some embodiments, souring is assayed by measuring parameters selected from the group including hydrogen sulfide production, fluid contamination, metal corrosion, and clogging of the engineered system. In some embodiments that may be combined with any of the preceding embodiments, the method further includes contacting the engineered system with a second composition including an additional souring inhibitor. In some embodiments, the second composition includes nitrate or (per)chlorate.

In another aspect, the present disclosure relates to a method for controlling souring including contacting an engineered system including a souring-promoting microbial community with a heated fluid at a temperature sufficient to inhibit souring in a unit volume of the engineered system. In some embodiments, the engineered system is an oil reservoir. In some embodiments, the temperature of the heated fluid present in the engineered system is at least about 60° C. In some embodiments, the temperature of the heated fluid present in the engineered system is about 125° C. or more. In some embodiments that may be combined with any of the preceding embodiments, the heated fluid includes seawater. In some embodiments that may be combined with any of the preceding embodiments, souring in a unit volume of the engineered system is inhibited by about 50% or more as compared to a corresponding unit volume in a system not contacted with the heated fluid. In some embodiments, souring is assayed by measuring parameters selected from the group including hydrogen sulfide production, fluid contamination, metal corrosion, and clogging of the engineered system. In some embodiments that may be combined with any of the preceding embodiments, the unit volume includes at least 90% of the total volume of the engineered system. In some embodiments that may be combined with any of the preceding embodiments, the method further includes contacting the engineered system with a composition including a souring inhibitor. In some embodiments, the composition includes a compound selected from the group including monofluorophosphate, nitrate, and (per)chlorate.

In another aspect, the present disclosure relates to a method for controlling souring including contacting an engineered system including a souring-promoting microbial community with a) a composition including a souring inhibitor, and b) a heated fluid, where the concentration of the souring inhibitor and the temperature of the heated fluid are sufficient to inhibit souring in a unit volume of the engineered system. In some embodiments, the engineered system is an oil reservoir. In some embodiments, the souring inhibitor is selected from the group including monofluorophosphate, nitrate, and (per)chlorate. In some embodiments, the souring inhibitor is monofluorophosphate and the concentration of the monofluorophosphate present in the engineered system is in the range of about 0.1 mM to about 5 mM. In some embodiments that may be combined with any of the preceding embodiments, the temperature of the heated fluid present in the engineered system is about 60° C. or more. In some embodiments, the heated fluid includes seawater. In some embodiments that may be combined with any of the preceding embodiments, souring in a unit volume of the engineered system is inhibited by about 50% or more as compared to a corresponding unit volume in a system not contacted with the inhibitor of souring or the heated fluid. In some embodiments, souring is assayed by measuring parameters selected from the group including hydrogen sulfide production, fluid contamination, metal corrosion, and clogging of the engineered system.

In another aspect, the present disclosure relates to a method for controlling souring including contacting an engineered system including a souring-promoting microbial community with a cooled fluid at a temperature sufficient to inhibit souring in a unit volume of the engineered system. In some embodiments, the engineered system is an oil reservoir. In some embodiments, the temperature of the cooled fluid present in the engineered system is below 0° C. In some embodiments that may be combined with any of the preceding embodiments, the cooled fluid includes seawater. In some embodiments that may be combined with any of the preceding embodiments, souring in a unit volume of the engineered system is inhibited by about 50% or more as compared to a corresponding unit volume in a system not contacted with the cooled fluid. In some embodiments, souring is assayed by measuring parameters selected from the group including hydrogen sulfide production, fluid contamination, metal corrosion, and clogging of the engineered system. In some embodiments that may be combined with any of the preceding embodiments, the unit volume includes at least 90% of the total volume of the engineered system. In some embodiments that may be combined with any of the preceding embodiments, the method further includes contacting the engineered system with a composition including a souring inhibitor. In some embodiments, the composition includes a compound selected from the group including monofluorophosphate, nitrate, and (per)chlorate.

In another aspect, the present disclosure relates to a method for controlling souring including contacting an engineered system including a souring-promoting microbial community with a) a composition including a souring inhibitor, and b) a cooled fluid, where the concentration of the souring inhibitor and the temperature of the cooled fluid are sufficient to inhibit souring in a unit volume of the engineered system. In some embodiments, the engineered system is an oil reservoir. In some embodiments, the souring inhibitor is selected from the group including monofluorophosphate, nitrate, and (per)chlorate. In some embodiments, the souring inhibitor is monofluorophosphate and the concentration of the monofluorophosphate present in the engineered system is in the range of about 0.1 mM to about 5 mM. In some embodiments that may be combined with any of the preceding embodiments, the temperature of the cooled fluid present in the engineered system is below 0° C. In some embodiments, the cooled fluid includes seawater. In some embodiments that may be combined with any of the preceding embodiments, souring in a unit volume of the engineered system is inhibited by about 50% or more as compared to a corresponding unit volume in a system not contacted with the inhibitor of souring or the cooled fluid. In some embodiments, souring is assayed by measuring parameters selected from the group including hydrogen sulfide production, fluid contamination, metal corrosion, and clogging of the engineered system.

### DESCRIPTION OF THE FIGURES

FIG. 1 illustrates the inhibition of growth over time of Desulfovibrio alaskensis G20 on a defined medium containing lactate (60 mM) and sulfate (30 mM) by different concentrations of sodium monofluorophosphate (MFP).

FIG. 2A-FIG. 2F illustrates dose-response curves of selected sulfate analog impact on growth and sulfide production of marine enrichment cultures. Compounds tested are nitrate (FIG. 2A), selenate (FIG. 2B), formaldehyde (FIG. 2C), perchlorate (FIG. 2D), monofluorophosphate (FIG. 2E), and benzalkonium chloride (FIG. 2F). Black boxes indicate growth, whereas white boxes indicate sulfide production. Values are expressed as a % (percentage) relative to a control marine culture that was not treated with the specified sulfate analog.

FIG. 3A-FIG. 3B illustrates dose-response curves of monofluorophosphate's impact on the growth of Desulfovibrio alaskensis G20 on sulfate and Azospira suillum PS with either perchlorate (FIG. 3B) or nitrate (FIG. 3A) as electron acceptors. White boxes indicate growth of Desulfovibrio alaskensis G20, whereas black boxes indicate growth of Azospira suillum PS. Values are expressed as a % (percentage) relative to a control culture that was not treated with monofluorophosphate. The results indicate that monofluorophosphate specifically inhibits sulfate reduction by Desulfovibrio while it has a limited effect on growth of Azospira suillum PS with either nitrate or perchlorate.

FIG. 4 illustrates an analysis of inhibition, by monomeric oxyanions, of growth and sulfidogenesis in marine enrichment cultures.

FIG. 5A-FIG. 5C illustrates dose-response curves of MFP against growth, sulfidogenesis, 16S amplicon phylum relative abundances, and dsrA copy number in a marine enrichment culture grown in the presence of varying concentrations of MFP for 48 h. FIG. 5A illustrates growth (filled symbols) and sulfide (open symbols). FIG. 5B illustrates phylum level relative abundances from 16S amplicon sequencing. Desulfovibrionales was the sole Proteobacterium observed. FIG. 5C illustrates sulfide, DsrA copy number, and Desulfovibrionales relative abundances.

FIG. 6A-FIG. 6F illustrate dose-response curves of selected sulfate analogs for growth of Desulfovibrio alaskensis G20 (open symbols) and Azospira suillum PS (closed symbols) with perchlorate (FIG. 6A) or nitrate (FIG. 6B) as electron acceptor. Synergy analysis between MFP and nitrate (FIG. 6C), perchlorate (FIG. 6D), nitrite (FIG. 6E), and chlorite (FIG. 6F) for inhibition of sulfidogenesis in marine enrichment cultures is also illustrated.

FIG. 7 illustrates an analysis of inhibition, by monomeric oxyanions, of Desulfovibrio alaskensis G20 wild-type and Rex mutant.

FIG. 8 illustrates an analysis of inhibition, by monomeric oxyanions, of Desulfovibrio alaskensis G20 wild-type under different growth conditions.

FIG. 9A illustrates dose-response curves against growth (OD 600) of wild-type Desulfovibrio alaskensis G20 grown in the presence of varying concentrations of monofluorophosphate (open symbols) and fluoride ion for 48 h. FIG. 9B-FIG. 9D illustrate growth of wild-type Desulfovibrio alaskensis G20 (open symbols) or the tn5::dde_2102 (crcB, fluoride efflux pump) (closed symbols) in the absence (FIG. 9B) or presence of (FIG. 9C) 1 mM MFP or 30 mM F⁻ (FIG. 9D).

FIG. 10 illustrates a model of the inhibition of ATP sulfuryase with MFP.

FIG. 11 illustrates replicated sediment bioreactors used for MFP dosing in mixed-species communities.

FIG. 12 illustrates in situ inhibition of sulfate reduction in the R7-9 bioreactors when MFP was dosed at 20 mM. The three dosing periods are shown along the 70 days of operation.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The present disclosure relates generally to methods for controlling souring in engineered systems, and more specifically to methods of controlling souring using chemical, physical, and combinatorial treatments of engineered systems to reduce hydrogen sulfide-associated souring in such engineered systems, such as oil reservoirs.

The present disclosure is based, at least in part, on Applicants discovery that the compound monofluorophosphate (MFP) is a specific inhibitor of sulfate-reducing microorganisms. As sulfate-reducing microorganisms can contribute to the production of hydrogen sulfide in engineered systems, such as oil reservoirs, and as hydrogen sulfide leads to souring of such reservoirs, monofluorophosphate may be used to control hydrogen sulfide production and souring of these systems. In addition, Applicants have developed a method of controlling the onset of souring through the prevention of reservoir cooling associated with water injection, such injection being a common practice during oil recovery processes. Heating of injected waters facilitates external control over the growth and metabolism of sulfate-reducing microorganisms that may be present in the reservoir, thus controlling their ability to produce hydrogen sulfide and contribute to souring.

Accordingly, the methods of the present disclosure provide both chemical and physical methods of controlling souring in engineered systems. These methods may be performed individually, or combinatorial methods using both chemical and physical measures may be used to control souring.

### Engineered Systems

The methods of the present disclosure relate to the use of chemical and/or physical approaches to controlling souring in engineered systems. The disclosed methods may be used to treat various systems where sulfate-reducing microorganisms (SRM) are causing, have caused, or have the potential to cause generation of sulfide-containing compounds, such as hydrogen sulfide (H₂S). Examples include aqueous environments such as pits or water-containment ponds and various marine environments. Additionally, the disclosed methods can be used to treat various systems containing sulfide-containing compounds such as H₂S. Examples include oil refineries, CO₂ storage wells, chemical plants, desalination plants, and wastewater treatment plants.

Examples of engineered systems in the present disclosure include those systems in the field of oil recovery. The injection of water is a commonplace practice to increase oil production beyond primary production yields by maintaining reservoir pressure and sweeping oil from the injection wells towards the production wells. If seawater is used as the water source, oil souring often occurs, as the seawater contains SRM and conditions conducive to the activity of SRM are created within the reservoir matrix. SRM are found in seawater, as they are indigenous to all marine environments.

Further examples of suitable systems include oil and gas reservoirs, oil-water separators, wellheads, oil or gas storage tanks, oil pipelines, a gas pipeline or a gas supply line, natural gas reservoir, cooling water tower, coal slurry pipelines, and other tanks or equipment that may contain SRM. In some embodiments, the system is the near-well environment of the oil or gas reservoir. In other embodiments, the system is the environment deeper in the reservoir. In some embodiments, the system is the entire oil or gas reservoir.

Another exemplary system includes CO₂ storage wells. Sulfide and oxygen present in the storage wells can stimulate microbial H₂SO₄ production in the wells in addition to the sulfidic sour gas. This can lead to extensive metal corrosion and concrete corrosion of the wells.

In some embodiments, the system is a processing plant that utilizes sulfide-containing compounds or compounds that produce sulfides as a byproduct. Examples of such compounds include, oil, gas, and hydrocarbons. Examples of processing plants include refineries, gas-liquid separators, and chemical plants.

In some embodiments, the system is waste waters bearing sulfur or its oxyanions from various industries. In preferred embodiments, the system is wastewater effluent from a pulp or paper mill In other embodiments, the system is wastewater effluent from a tannery. In other embodiments, the system is wastewater effluent from a textile mill. Additional suitable engineered systems for use in the methods of the present disclosure will be readily apparent to one of skill in the art.

### Microbial Communities

Certain methods of the present disclosure relate to controlling souring in engineered systems, where the engineered system contains a microbial community. A microbial community generally refers to a collection of different species of microorganisms. Certain methods of the present disclosure are useful at controlling souring where the engineered system contains a souring-promoting microbial community. Souring-promoting microbial communities include those communities that contain microorganisms that are sulfate-reducing microorganisms (SRM) or that are otherwise capable of producing hydrogen sulfide.

Certain aspects of the present disclosure relate to inhibiting sulfate-reduction by (dissimilatory) sulfate-reducing microorganisms (SRM). As used herein, the terms “(dissimilatory) sulfate-reducing microorganism,” “sulfate-reducing microorganisms,” and “SRM,” are used interchangeably and refer to microorganisms that are capable of reducing sulfur or its oxyanions to sulfide ions.

Dissimilatory sulfate-reducing microorganisms (SRM) of the present disclosure may reduce sulfate in large amounts to obtain energy and expel the resulting sulfide as waste. Additionally, SRM of the present disclosure may utilize sulfate as the terminal electron acceptor of their electron transport chain. Typically, SRM are capable of reducing other oxidized inorganic sulfur compounds including, for example, sulfite, thiosulfate, and elemental sulfur, which may be reduced to sulfide as hydrogen sulfide.

Dissimilatory sulfate-reducing microorganisms (SRM) of the present disclosure are commonly found in sulfate rich environments, such as seawater, sediment, and water rich in decaying organic material. Thus, SRM are common in typical floodwater utilized in oil reservoirs, and are the major cause of sulfide production in oil reservoir souring (Vance and Thrasher, Petroleum Microbiology, eds B. Ollivier & M. Magot, ASM Press, 2005).

Dissimilatory sulfate-reducing microorganisms (SRM) of the present disclosure may include, for example, organisms from both the Archaea and Bacteria domains. Examples of SRM also include, for example, members of the δ sub-group of Proteobacteria, such as Desulfobacterales, Desulfovibrionales, and Syntrophobacterales. In some embodiments, the SRM are from the species Desulfovibrio and Desulfuromonas. In some embodiments, the SRM is Desulfovibrio alaskensis G20. Other sulfate-reducing microorganisms (SRM) will be readily apparent to one of skill in the art.

In some embodiments, souring-promoting microbial communities of the present disclosure include both sulfate-reducing microorganisms and non-sulfate-reducing microorganisms. Certain methods of the present disclosure, such as certain chemical methods, may be particularly useful for specifically inhibiting sulfate-reducing microorganisms without having a significant impact on the general metabolism of the non-sulfate-reducing microorganisms. As the presence of members of the microbial community which do not contribute to souring (e.g. certain non-sulfate-reducing microorganisms) may be beneficial, certain methods of the present disclosure may preserve the activity of these members while specifically inhibiting the sulfidogenic activity of sulfate-reducing microorganisms. Microorganisms that may be useful in engineered systems of the present disclosure may include, for example, (per)chlorate-reducing microorganisms or nitrate-reducing microorganisms.

After being subjected to certain souring control treatments of the present disclosure such as, for example, treatment with a chemical inhibitor of sulfate-reducing microorganisms, non-sulfate-reducing microorganisms in an engineered system may retain, for example, at least about 50%, at least about 55%, at least about 60%, at least about 65%, at least about 70%, at least about 75%, at least about 80%, at least about 85%, at least about 90%, at least about 95%, at least about 99%, or about 100% of their growth or growth rate as compared to a corresponding control microorganism such as, for example, a corresponding non-sulfate-reducing microorganism that was not subjected to a corresponding souring control treatment of the present disclosure. In certain embodiments of physical methods of controlling souring, such as the use of heated fluid or cooled fluid, certain temperatures will effectively inhibit all microorganisms present in the engineered system.

### Methods of Controlling Souring

The methods of the present disclosure involve approaches for controlling or regulating souring in an engineered system. Souring is generally considered to be controlled in an engineered system when souring is inhibited to some degree. For example, souring may be controlled in an engineered system when souring is decreasing (e.g. hydrogen sulfide levels in the system are decreasing over time) or when souring is being maintained at a constant level (e.g. hydrogen sulfide levels in the system are at a constant level over time). Accordingly, souring may be considered to be controlled in an engineered system when souring is not increasing (e.g. when hydrogen sulfide levels in the system are not increasing over time). The methods of the present disclosure provide chemical approaches, physical approaches, and a combination of chemical and physical approaches for controlling souring in an engineered system.

In some embodiments, the chemical and/or physical approaches to controlling souring as disclosed herein should be administered such that they are sufficient to inhibit souring in a unit volume of the engineered system. A unit volume of an engineered system is generally a specific volume at a given region within the system. One of skill in the art would appreciate that a unit volume experiencing inhibited souring relative to other comparable systems or other regions or unit volumes within the same system may vary. For example, in embodiments where the engineered system is an oil reservoir, the unit volume may be the volume encompassed by an injection well. In some embodiments, the unit volume may be the volume encompassed by a production well. In some embodiments, the unit volume may by the total volume of the engineered system, such as the total volume of an oil reservoir. The unit volume may also be experiencing inhibition of souring over a time interval. For example, a unit volume may be experiencing inhibition of souring over time if the levels of hydrogen sulfide in that unit volume are not increasing over time such as, for example, over a period of hours or days after treatment with a physical and/or chemical approach for controlling souring of the present disclosure. One of skill in the art would appreciate various approaches which may be used to determine if inhibition of souring is occurring in the engineered system.

A unit volume experiencing inhibition of souring may include, for example, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 99%, or at least about 100% of the total volume of the engineered system.

A unit volume of an engineered system may be considered to be experiencing the inhibition of souring if at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 99%, or at least about 100% of souring activity has been inhibited in the unit volume. In some embodiments, souring in a unit volume of an engineered system contacted with a chemical compound which is an inhibitor of souring, or a souring inhibitor, is inhibited by about 50% or more as compared to a corresponding unit volume in a system not contacted with a chemical compound of the present disclosure that inhibits souring, such as monofluorophosphate. In some embodiments, souring in a unit volume of an engineered system contacted with a heated fluid of the present disclosure is inhibited by about 50% or more as compared to a corresponding unit volume in a system not contacted with a heated fluid of the present disclosure.

Various parameters may be used to assess souring activity, as will be appreciated by one of skill in the art. Parameters used to assess or measure souring activity may include, for example, the production of hydrogen sulfide, the depletion of sulfur or its oxyanions (e.g. sulfate, sulfite, thiosulfate, sulfur dioxide), the presence and/or degree of fluid contamination, the presence of metal corrosion, and evidence of clogging of the engineered system. Measuring hydrogen sulfide levels is a standard chemical analysis and may be performed using, for example, Draeger tubes or online gas chromatographs. The inhibition of souring in a unit volume of the engineered system may be determined, for example, by comparison to a comparable unit volume in an engineered system not treated with a chemical and/or physical treatment of the present disclosure, or by comparison of similar unit volumes in a treated engineered system over time.

Chemical Approaches for Controlling Souring

Certain methods of the present disclosure relate to the use of chemical compounds for controlling souring in an engineered system. Specifically, the present disclosure provides methods of adding chemical compounds, where the chemical compound is an inhibitor of souring, to an engineered system to control souring in the system. Accordingly, the chemical compounds of the present disclosure may be used to control souring in engineered systems. In some embodiments, one or more chemical compounds can be added in a batch or a continuous manner The method of addition depends on the system being treated. For example, in embodiments where the system is a single oil well, the one or more chemical compounds can be added in a single or multiple sequential batch injections. In other embodiment where the system is an entire oil-recovery system, the one or more chemical compounds can be added in a continuous process.

In embodiments where the method is used to control (e.g. decrease) the amount of sulfide-containing compounds in an oil reservoir, the chemical compounds can be added into injected water at the beginning of the flooding process. Alternatively, the chemical compounds can also be added to makeup waters out in the field after souring has been observed. In other embodiments, the chemical compounds can be added at the wellhead.

In further embodiments, chemical compounds of the present disclosure are added to CO₂ storage wells to reduce or inhibit the formation of sour gas by sulfate-reducing microorganisms or sulfur oxidizing bacteria present in the storage wells. In this manner, the chemical compounds can protect the storage wells from the metal corrosion and concrete corrosion that may occur as the result of sour gas formation.

The chemical compounds added to engineered systems of the present disclosure should be capable of inhibiting souring in the system. Methods of the present disclosure involving the addition of chemical compounds that are inhibitors of souring to an engineered system may be applicable across various pH, temperature, and salinity ranges in the engineered system. One of skill in the art would readily be able to determine appropriate methods as described herein depending on the specific environmental parameters of a given engineered system.

In some embodiments, the methods of the present disclosure involve contacting an engineered system with a composition containing monofluorophosphate. In some embodiments, the methods of the present disclosure involve contacting an engineered system with both monofluorophosphate and an additional chemical compound such as, for example, (per)chlorate or other chlorine oxyanion, and nitrite or nitrate.

Monofluorophosphate may be contacted with an engineered system of the present disclosure in a variety of forms. For example, the composition containing monofluorophosphate may contain an aqueous solution of a salt of monofluorophosphate. Exemplary salts of monofluorophosphate may include, for example, sodium salts, ammonium salts, potassium salts, and calcium salts of monofluorophosphate. Various other suitable salts of monofluorophosphate will be readily apparent to one of skill in the art. Further, delivery of monofluorophosphate may be achieved in a variety of ways which will be apparent to one of skill in the art. For example, a salt of monofluorophosphate may be dissolved in a fluid, such as seawater, that is to be added to the engineered system.

Monofluorophosphate should be present in the engineered system at a concentration which is sufficient to inhibit souring in a unit volume of the system. Applicants have demonstrated herein that monofluorophosphate can inhibit sulfate-reducing microorganisms, and thus may be used to control the souring of engineered systems initiated by the production of hydrogen sulfide by sulfate-reducing microorganisms present in the system. The concentration of monofluorophosphate present in the engineered system, or in a specific unit volume of the engineered system may be, for example, at least about 0.1 mM, at least about 0.2 mM, at least about 0.3 mM, at least about 0.4 mM, at least about 0.5 mM, at least about 0.6 mM, at least about 0.7 mM, at least about 0.8 mM, at least about 0.9 mM, at least about 1 mM, at least about 1.5 mM, at least about 2 mM, at least about 2.5 mM, at least about 3 mM, at least about 3.5 mM, at least about 4 mM, at least about 4.5 mM, or at least about 5 mM or more monofluorophosphate. In some embodiments, the concentration of monofluorophosphate present in the engineered system is about 0.8 mM. In some embodiments, the concentration of monofluorophosphate present in the engineered system is in the range of about 0.1 mM to about 5 mM.

Various other chemical compounds may be used to control souring according to the methods of the present disclosure. For example, chlorine oxyanions may be added to an engineered system. Examples of chlorine oxyanions may include, for example, hypochlorite, chlorine dioxide, chlorite, chlorate, perchlorate, and mixtures thereof. Without wishing to be bound by theory, it is believed that chlorine oxyanions inhibit the activity of sulfate reducing microorganisms and also stimulate (per)chlorate-reducing activity of (per)chlorate-reducing microorganisms in a system, which results in a decrease in sulfide-containing compounds in the system. Further, and without wishing to be bound by theory, it is believed that chlorine oxyanions may also biologically and chemically react with sulfide in the sulfide-containing compound to produce sulfur. Accordingly, the methods of the present disclosure also relates to the addition of (a) (per)chlorate-reducing microorganisms and (b) chlorine oxyanions, or compounds which yield the chlorine oxyanions, to an engineered system at a concentration sufficient to stimulate (per)chlorate-reducing activity of the (per)chlorate-reducing microorganisms, thereby decreasing the amount of one or more sulfide-containing compounds in the system and thus inhibiting and controlling souring. (Per)chlorate reducing microorganisms may be added to the engineered system, or they may otherwise already be present in the engineered system.

Chlorine oxyanions should be added to an engineered system at a concentration sufficient to stimulate (per)chlorate-reducing activity of the (per)chlorate-reducing microorganisms. This concentration may be dependent upon the parameters of the system being treated by the provided method. For example, characteristics of the system, such as its volume, surrounding pH, temperature, sulfate concentration, etc., will dictate how much chlorine oxyanions are needed to stimulate the (per)chlorate-reducing activity of the (per)chlorate-reducing microorganisms. Without wishing to be bound by theory, it is believed that a ratio of three S²⁻ ions to one ClO₃⁻ ion will completely oxidize all of the sulfide to elemental sulfur. Additionally, it is believed that this ratio changes to 4:1 with perchlorate, and 2:1 with chlorite or chlorine dioxide. Accordingly, in some embodiments, the chlorine oxyanions added are at a ratio with sulfide that is sufficient to completely oxidize the sulfide to elemental sulfur.

In embodiments where perchlorate (ClO₄⁻) is added to the engineered system, the perchlorate can be added in an amount that is at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least72%, at least 73%, at least 74%, at least 75%, at least 80%, at least 85%, at least 90%, at least 95%, or at least 100% of the amount (i.e., concentration) of sulfate present in the system. Methods for determining the concentration of sulfate present in a system, such as an oil reservoir, are well known in the art. For example, seawater, which can be used as floodwater in an oil reservoir, generally has a sulfate concentration of about 20-30 mM.

The chlorine oxyanions may be added to the system in various forms. For example, the counter ion is not critical and accordingly various forms of the chlorine oxyanions may be added so long as the ions perform their desired function. Examples of suitable counter ions may include, for example, chlorine oxyanion acids and salts of sodium, potassium, magnesium, calcium, lithium, ammonium, silver, rubidium, and cesium. Compounds or methods (e.g. electrolysis) which yield chlorine oxyanions upon addition to the system can also be used.

Other chemical compounds, such as nitrates and nitrites, may also be added to the engineered system to control souring. Nitrite, in small amounts, is very toxic to sulfate-reducing microorganisms. Accordingly, nitrite may be added to the engineered system alone or in combination with monofluorophosphate and/or (per)chlorate (or other chlorine oxyanion) to inhibit sulfate-reducing microorganisms, thereby inhibiting sulfidogenesis and controlling souring. In certain embodiments, the nitrite or nitrate is added at a concentration sufficient to inhibit the sulfate-reducing microorganisms and thus inhibit souring. Generally, the nitrite or nitrate can be added in combination with (per)chlorate at a (per)chlorate:nitrite ratio of at least 10:1, at least 20:1, at least 30:1, at least 40:1, at least 50:1, at least 60:1, at least 70:1, at least 80:1, at least 90:1, at least 100:1, at least 110:1, at least 120:1, at least 130:1, at least 140:1, at least 150:1, at least 160:1, at least 170:1, at least 180:1, at least 190:1, at least 200:1, or more. In certain preferred embodiments, (per)chlorate and nitrite are added in a ratio of 100:1. For example 10 mM of (per)chlorate and 100 μM of nitrite or nitrate may be added to the system.

In some embodiments, nitrate-reducing microorganisms and nitrate may also be added to an engineered system to expand the population of nitrate-reducing microorganisms in the system to further control souring. Nitrate-reducing bacteria can reduce chlorate to chlorite, and it has been shown that, in pure culture, the produced chlorite can kill the nitrate-reducing bacteria. However, without wishing to be bound by theory, it is believed that in a sulfidogenic environment, such as an oil reservoir, the chlorite can inhibit sulfate-reducing microorganisms. Accordingly, in certain embodiments, nitrate may be added to an engineered system of the present disclosure, such as an oil reservoir, in an amount sufficient to stimulate nitrate reduction to expand the population of nitrate-reducing microorganisms in the system. Once the microbial population has been expanded, chlorine oxyanions, such as (per)chlorate, can be added to biogenically produce chlorite in an amount sufficient to inhibit sulfate-reducing microorganisms and souring.

The chemical compounds of the present disclosure that inhibit souring may be added to an engineered system in various combinations. For example, monofluorophosphate may be added to the system in combination with (per)chlorate (or other chlorine oxyanion), in combination with nitrite and/or nitrate, or in combination with both (per)chlorate (or other chlorine oxyanion) and nitrite and/or nitrate. Without wishing to be bound by theory, it is thought that the use of combinations of chemical compounds that inhibit souring may further contribute to the control of souring in the system as compared to controlling souring with a single chemical compound of the present disclosure.

Physical Approaches for Controlling Souring

Certain methods of the present disclosure relate to the use of physical treatments of engineered systems to control souring in the engineered system. Specifically, the present disclosure provides methods of adding heated fluids, or alternatively, adding cooled fluids, to an engineered system to control souring in the system. Accordingly, the addition of a heated fluid or a cooled fluid to an engineered system of the present disclosure may be used to control souring in the engineered system. In some embodiments, the heated fluid or the cooled fluid can be added in a batch or a continuous manner. The method of addition of the heated fluid or the cooled fluid depends on the system being treated. For example, in embodiments where the system is a single oil well, the heated fluid or the cooled fluid can be added in a single or multiple sequential batch injections. In other embodiment where the system is an entire oil-recovery system, the heated fluid or the cooled fluid can be added in a continuous process. In some embodiments, the heated fluid or the cooled fluid can be added to the engineered system in several large contiguous doses, as opposed to a continuous dose where heated fluid or the cooled fluid is continuously being delivered to the system.

Heated Fluid

Various engineered systems may benefit from the addition of a heated fluid to control souring of the system. For example, during oil recovery in oil reservoirs, injection of large volumes of seawater at an ambient temperature of ˜4° C. is a common practice during secondary oil recovery procedures, but this practice generally results in significant heat loss from the reservoir, creating temperature gradients across the flooded reservoir volume between the injection-producing well pair. As such, conditions conducive to microbial metabolism are created in the cooled matrix, with the resultant biogenesis of H₂S and onset of souring of the system. Accordingly, in some embodiments, the methods of the present disclosure relate to the addition of a heated fluid to an oil reservoir during secondary oil recovery procedures in order to inhibit souring in the system. Without wishing to be bound by theory, it is thought that heated fluid will increase the internal temperature of the engineered system such that souring of the system will be inhibited.

Various fluids may be heated for use in controlling souring in an engineered system of the present disclosure. A fluid to be heated may include, for example, water, or more specifically, seawater. In some embodiments, the heated fluid may be heated to a temperature such that steam is produced. Accordingly, in some embodiments, the heated fluid is steam. The physical nature of the heated fluid (e.g. water or steam) is determined as much by pressure as by temperature. For example, at a temperature of 121° C. and at a pressure of 115 psi, the fluid will be water (liquid), whereas at a temperature of 121° C. and at atmospheric pressure, the fluid will be steam (gas).

The heated fluid should be present in the engineered system at a temperature which is sufficient to inhibit souring in a unit volume of the system. For engineered systems which have an internal temperature that supports microbial life, such as sulfate-reducing microorganisms, any increase in the temperature of the engineered system may result in a reduction of the microbial active zone (biozone). The temperature of the heated fluid present in the engineered system, or in a specific unit volume of the engineered system may be, for example, at least about the same temperature as the intrinsic temperature of the engineered system. The temperature of the heated fluid present in the engineered system, or in a specific unit volume of the engineered system may be, for example, at least about 30° C., at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., at least about 95° C., at least about 100° C., at least about 105° C., at least about 110° C., at least about 115° C., at least about 120° C. or more. In some embodiments, the temperature of the heated fluid present in the engineered system is in the range of about 30° C. to about 120° C.

In some embodiments, the temperature of the heated fluid present in the engineered system, or in a specific unit volume of the engineered system may be, for example, at least about 121° C., at least about 125° C., at least about 130° C., at least about 135° C., at least about 140° C., at least about 145° C., at least about 150° C., at least about 155° C., at least about 160° C., at least about 165° C., at least about 170° C., at least about 175° C., at least about 180° C., at least about 185° C., at least about 190° C., at least about 195° C., at least about 200° C., at least about 210° C., at least about 220° C., at least about 230° C., at least about 240° C., at least about 250° C., at least about 260° C., at least about 270° C., at least about 280° C., at least about 290° C., or at least about 300° C. or more. In some embodiments, the temperature of the heated fluid present in the engineered system is in the range of about 121° C. to about 300° C. In some embodiments, the temperature of the heated fluid present in the engineered system is at least about 121° C. In some embodiments, the temperature of the heated fluid present in the engineered system is at least about 125° C. or more. Without wishing to be bound by theory, it is thought that temperatures of 121° C. or above will kill all microorganisms present in the engineered system.

Various methods of heating a fluid of the present disclosure are known in the art and are described herein. For example, heating of the fluid can be achieved through engineered heat recovery from hot produced reservoir fluids, in addition to heat available through the combustion of produced natural gases. The fluid may also be heated using a heating device, such as a device that is suitable for the heating of large volumes of water. Further, fluids injected into an oil reservoir could be heated with produced natural gas or a counter heat exchanger could be used to transfer heat from the produced fluids to the injection fluids. For oil reservoirs, if the oil/gas flow rates are large, then some or all of the heat contained therein could heat the injection fluids. Any additional heat requirements could be obtained from an auxiliary heater furnace to provide heat from the combustion of natural gas (or other hydrocarbon) to the injection fluids such that the fluids are able to reach or exceed 121° C. For oceanic oil reservoirs, the heat exchange equipment could be placed at the bottom of the ocean, although this would involve running lines back and forth from the production to the injection points in 4° C. water.

The addition of a heated fluid to an engineered system of the present disclosure may aid in reducing the biozone in which sulfidogenic activity may occur in the system. A biozone generally refers to a unit volume in a system that is capable of supporting biosouring (e.g. souring that occurs as a result of the production of hydrogen sulfide by sulfate-reducing microorganisms). Heating of an engineered system via delivery of heated fluid to the system may increase the temperature of biozones in the system such that sulfidogenic activity cannot be supported. In some embodiments, a unit volume experiencing an inhibition of souring after being contacted with a heated fluid includes a volume that is at least 90% of the total volume of the engineered system.

Cooled Fluid

Similarly, various engineered systems may benefit from the addition of a cooled fluid to control souring of the system. The purpose of the cooled fluid is to decrease the internal temperature of the engineered system to a temperature that is not conducive to supporting sulfate-reducing metabolism. Without wishing to be bound by theory, it is thought that the cooled fluid will decrease the internal temperature of the engineered system such that souring of the system will be inhibited.

Various fluids may be cooled for use in controlling souring in an engineered system of the present disclosure. A fluid to be cooled may include, for example, water, or more specifically, seawater. In some embodiments, the cooled fluid may be cooled to a temperature below 0° C. for subsequent injection into an engineered system of the present disclosure. The exact physical nature of the cooled fluid is determined as much by pressure as by temperature.

The cooled fluid should be present in the engineered system at a temperature which is sufficient to inhibit souring in a unit volume of the system. For engineered systems which have an internal temperature that supports microbial life, such as sulfate-reducing microorganisms, any decrease in the temperature of the engineered system may result in a reduction of the microbial active zone (biozone). The temperature of the cooled fluid present in the engineered system, or in a specific unit volume of the engineered system may be, for example, at most about −10° C., at most about −5° C., at most about 0° C., at most about 5° C., at most about 10° C., at most about 15° C., at most about 20° C., at most about 25° C., or at most about 30° C. In some embodiments, the temperature of the cooled fluid present in the engineered system is in the range of about 0° C. to about 30° C. In some embodiments, the temperature of the cooled fluid present in the engineered system is below 0° C.

Various methods of cooling a fluid of the present disclosure are known in the art and are described herein. For example, the fluid may be cooled using a cooling device, such as a device that is suitable for the cooling of large volumes of water.

The addition of a cooled fluid to an engineered system of the present disclosure may aid in reducing the biozone in which sulfidogenic activity may occur in the system. A biozone generally refers to a unit volume in a system that is capable of supporting biosouring (e.g. souring that occurs as a result of the production of hydrogen sulfide by sulfate-reducing microorganisms). Cooling of an engineered system via delivery of cooled fluid to the system may decrease the temperature of biozones in the system such that sulfidogenic activity cannot be supported. In some embodiments, a unit volume experiencing an inhibition of souring after being contacted with a cooled fluid includes a volume that is at least 90% of the total volume of the engineered system.

Combination Approaches for Controlling Souring

Certain methods of the present disclosure relate to the use of both chemical and physical treatments of engineered systems to control souring in the engineered system. Specifically, the present disclosure provides methods of adding one or more chemical compounds that are inhibitors of souring in addition to adding heated fluids or cooled fluids to an engineered system to control souring in the system. Accordingly, the addition of both chemical compounds that are inhibitors or souring and a heated fluid or a cooled fluid to an engineered system of the present disclosure may be used to control souring in the engineered system.

Various combinations of physical and chemical treatments of engineered systems will be readily apparent to one of skill in the art in view of the present disclosure. For example, a heated fluid or a cooled fluid may be added to the engineered system where the heated fluid or the cooled fluid has also been supplemented with one or more chemical compounds that are inhibitors of souring such as, for example, monofluorophosphate, (per)chlorate, and/or nitrite or nitrate.

The concentration of the inhibitor of souring and the temperature of the heated fluid or the cooled fluid present in the engineered system should be sufficient to inhibit souring in a unit volume of the engineered system. One of skill in the art would readily be able to determine such concentrations and/or temperatures in view of the present disclosure. Without wishing to be bound by theory, it is thought that combination approaches may further contribute to the control of souring in the system. For example, the concentration of a chemical compound that is an inhibitor of souring, such as monofluorophosphate, may be able to be reduced in the engineered system if the inhibitor is added to the system in a heated fluid of the present disclosure such as, for example, seawater heated to above 60° C.

### EXAMPLES

The following Examples are offered to illustrate provided embodiments and are not intended to limit the scope of the present disclosure.

### Example 1

### Monofluorophosphate as a Selective Inhibitor of Sulfate-Reducing Microorganisms

This Example demonstrates the use of monofluorophosphate as a specific inhibitor of microbial hydrogen sulfide production. Despite decades of research, only a few compounds have been identified as specific inhibitors of microbial sulfate reduction (e.g. molybdate, selenate, nitrate, nitrite, and more recently, perchlorate and chlorate). This Example describes the screening of “sulfate analogs” to identify alternative potent and specific inhibitors of sulfate reduction. It was found that monofluorophosphate (MFP) is not only a specific inhibitor of sulfate-reducing microorganisms, but has other beneficial qualities including relatively low toxicity to eukaryotic organisms, high stability at neutral pH and the potential for beneficial interactions with rock matrices. MFP may be a practical, non-toxic and cost-effective alternative to other sulfate-reduction inhibitors in ecological studies and industrial ecosystems.

### Introduction

Hydrogen sulfide (H₂S) biogenesis by sulfate reducing microorganisms (SRM) is a potentially deleterious metabolism. For example, in the case of oil recovery, microbially produced H₂S in reservoir gases and fluids is the basis of souring (Gieg et al., 2011) with an associated annual cost estimated in the order of $90 billion. Souring typically occurs after initiation of secondary recovery processes involving water injection to push oil out of the reservoir matrix (Gieg et al., 2011; Youssef et al., 2008). If seawater is used, sulfidogenesis ensues as conditions conducive to the activity of SRM are created within the rock matrix. This is because sulfate is one of the dominant ions present in seawater (˜20-30 mM) and SRM are indigenous to all marine environments. As such, seawater provides both an inoculum and an electron acceptor to the oil reservoir.

Furthermore, labile carbon in the form of simple organic acids (acetate, proprionate, etc.) are often present in significant quantities in reservoir formation waters at concentrations as high as 1,500 mg L⁻¹ (Vance et al., 2005). Many SRM are known to be capable of utilizing diverse hydrocarbons, including both aliphatic and aromatic structures in addition to volatile fatty acids (VFA) (Aeckersberg et al., 1991; Anderson et al., 2000; Annweiler et al., 2000; Bedessem et al., 1997; Beller et al., 1992; Beller et al., 1996; Caldwell et al., 1998; Coates et al., 1996; Coates et al., 1996; Edwards et al., 1994; Galushko et al., 1999; Laban et al., 2009; Lovley et al., 1995; Widdel et al., 1992) which provide a seemingly limitless carbon and energy supply to the active populations in an oil reservoir. Once established, SRM can generate large quantities of H₂S across a souring field. For example, the Skjold field in the North Sea produced 1.15 tons of H₂S per day (Larsen, 2002). The generation of H₂S by SRM results in a variety of oil recovery problems, including contamination of crude oil, metal corrosion, and the precipitation of metal sulfides that subsequently plug pumping wells. Sour service metallurgy for wells, pipelines, and pump systems carry an estimated cost premium of 2% to 20% of total project installation costs (Vance et al., 2005). Sour production facilities also entail additional costs associated with prevention of operator exposure to toxic H₂S, reduced oil-water separator performance, management of iron sulfide solids that interfere with produced water cleanup and recycle, and accumulation of iron-sulfide deposits that foul equipment and enhance equipment corrosion. Additional revenue loss may result from policy restrictions imposed on pumping high volumes of oil and gas with excessive H₂S concentrations through export lines to prevent corrosion and ensure system integrity (Vance et al., 2005).

Studies performed over the years have identified several known or putative sulfate reduction inhibitors. For example, molybdate has been extensively used in ecological studies and in engineering settings to inhibit sulfide production. Early work with purified ATP sulfurylase enzymes suggested molybdate inhibited the ATP sulfurylase by non-productive ATP hydrolysis. Such “molybdolysis” was proposed to be a central mechanism of inhibition of sulfate-reducing microorganisms by molbydate. Taylor and Oremland observed that after 60 minutes, cell suspensions of Desulfovibrio treated with molybdate had ˜10% as much intracellular ATP as controls. In contrast, molybdate treated cell suspensions of nitrate reducing bacteria showed ˜80% intracellular ATP as controls. The authors concluded that consumption of ATP through non-productive catalysis by ATP sulfurylase explained their results. However, because the authors did not measure the initial ATP concentrations in the cell suspensions and ATP is consumed for cellular maintenance and by metal efflux pumps, it is unknown whether the lower ATP concentrations in the molybdate treated cells was due to inhibited synthesis of ATP or stimulated ATP hydrolysis. Molybdate is also well-known as an inhibitor of kinases, and the influence on cellular ATP may reflect an impact on phosphotransfer enzymes. In another study, Newport and Newdell isolated a mutant of Desulfovibrio vulgaris 11779 that was resistant to molybdate in growth assays. This mutant displayed increased consumption of sulfate in cell suspensions relative to wild-type cells, and the authors concluded that the mutation affected a sulfate transporter, and that molybdate competed with sulfate for transport into cells.

Despite the equivocal evidence for molybdate as a specific inhibitor of sulfate reduction, a number of studies have assessed its utility in controlling sulfide emissions from industrial systems (Xu et al., 2011). Of particular concern in these studies is that frequently the authors only measure inhibition of hydrogen sulfide, and do not assess the impacts of molybdate on other microbes in the microbial community members or other metabolisms. When this has been assessed for example, when methanogenesis is also measured, methanogenesis was also shown to be inhibited by molybdate (Patidar et al., 2005). In the presence of hydrogen sulfide, molybdate is also reduced to form molybdenum sulfide complexes (Biswas et al., 2009). This reaction is catalyzed by free cysteine or protein-thiols associated with bacteria (Chen et al., 1998). Thus, it remains to be determined if the active inhibitor of sulfate-reducing microorganisms is molybdenum sulfide complexes rather than free MoO₄⁻.

Halooxyanions have also been investigated as inhibitors of sulfate reduction. For example, perchlorate, chlorate, bromate, iodate, and periodate have a wide range of stabilities towards redox reactions. Chlorate is widely used in eukaryotic systems to inhibit assimilatory sulfate reduction, and has been demonstrated to be relatively specific in that it does not inhibit key phosphorylation reactions. However, bromate, iodate and periodate rapidly react with sulfide in media and are consumed, and they will also react with reduced iron. Thus, their utility as inhibitors of sulfate reduction or sulfide production is likely limited to scavenging of sulfide.

Monofluorophosphate is isoelectronic with SO₄²⁻ and was first considered as an inhibitor of sulfate reduction in an early study by Postgate (Postgate, 1952). Subsequently, very little work on monofluorophosphate was conducted, as the more potent inhibitors selenate and molybdate were championed in early work to identify sulfate reduction inhibitors. In recent years, monofluorophosphate has been demonstrated to be an effective inhibitor of abiotic corrosion. While the precise mechanism of inhibition is debated, additions of monofluorophosphate have been shown to decrease the abiotic corrosion of steel in concrete (Ngala et al., 2003; Soylev et al., 2008). Most data on the biological effects of monofluorophosphate come from studies on oral bacteria. Without wishing to be bound by theory, it is thought that alkaline phosphatases release free fluoride ion from monofluorophosphate and that this free fluoride is the primary toxic compound to microorganisms.

### Materials and Methods

Media, Strains, and Culture Conditions

Desulfovibrio species were cultivated in basal Tris-buffered lactate/sulfate media. The media contained 8 mM MgCl₂, 20 mM NH₄Cl, 0.6 mM CaCl₂, 2 mM KH₂PO₄, 0.06 mM FeCl₂, and 30 mM Tris-HCl. 60 mM sodium lactate and 30 mM sodium sulfate were added. Trace elements and vitamins were added from stocks according to previously described protocols (Beller et al., 1992; Beller et al., 1996) and the media was brought to a pH of 7.4 with 0.5 M HCl. The media was degassed with N₂ and either sterile-filtered in an anaerobic chamber for microplates or dispensed into anoxic vials. The incubation temperature for all growth experiments was 30° C.

Desulfovibrio were cultivated both in sealed anaerobic glass culture tubes (Hungate tubes, Bellco) and polystyrene 96 well microplates (Costar) and 384 well microplates (Nunc). Desulfovibrio were always recovered from 1 mL freezer stocks in 10 mL anoxic basal media in sealed Hungate tubes with 1 g/L yeast extract and 1 mM sodium sulfide and washed in basal media to remove residual yeast extract prior to inoculation of microplates or tubes for growth experiments.

For cultivation of Desulfovibrio in microplates, plates were inoculated anaerobically in a glove bag. Desulfovibrio were resuspended in 2× concentrated anoxic basal media containing 2 mM sodium sulfide and added at a 2× dilution to microplates containing water or compounds. Nitrate, nitrite, perchlorate, and chlorate were sodium salts (Sigma). DETANONOate (Cayman) is a nitric oxide donor with a 56 hour half-life at 22-25° C. at pH 7.4, but stable in base. Stocks in 0.1 M NaOH were added to plates or Hungate tubes and serial dilutions made immediately prior to inoculation. Microplates were filled with compounds aerobically using a Biomek F×P liquid handling robot (Beckman instruments) and allowed to degas in Coy anaerobic chambers for 48 hours prior to inoculation. All microplates were inoculated at an initial OD₆₀₀ of 0.02 and the growth rate determined for timepoints between 16 and 48 hours. Microplates were sealed with PCR plate seals (VWR) and kept in anoxic BD GasPak anaerobic boxes except when timepoints were being recorded.

Marine enrichment cultures were enriched from marine sediments collected from San Francisco Bay. 2 g/L yeast extract was added to autoclaved seawater and cultures to make seawater media. Enrichments were passaged or frozen in −80° C. glycerol stocks. IC₅₀s against growth and sulfidogenesis were determined for cells pre-grown in sealed anoxic Hungate tubes that were centrifuged, resuspended in autoclaved seawater and added at 2× dilutions to microplates containing compounds diluted in autoclaved seawater media at an initial OD₆₀₀ of 0.02.

Determination of IC₅₀ Values for Compounds

For determination of IC₅₀ values for inhibitors, bacteria were cultured in an anaerobic box in 96-well microplates covered with clear plate seals. Inhibitors over a range of concentrations were added to triplicate wells and growth was determined by optical density at 600 nm. Sulfide production was determined by the Cline assay.

Data Analysis

Growth and sulfide production data were plotted as a percentage of that observed in non-amended controls against inhibitor concentration from which a best-fit curve was determined to calculate the inhibitor concentration that resulted in a 50% decrease in activity (IC₅₀).

### Results

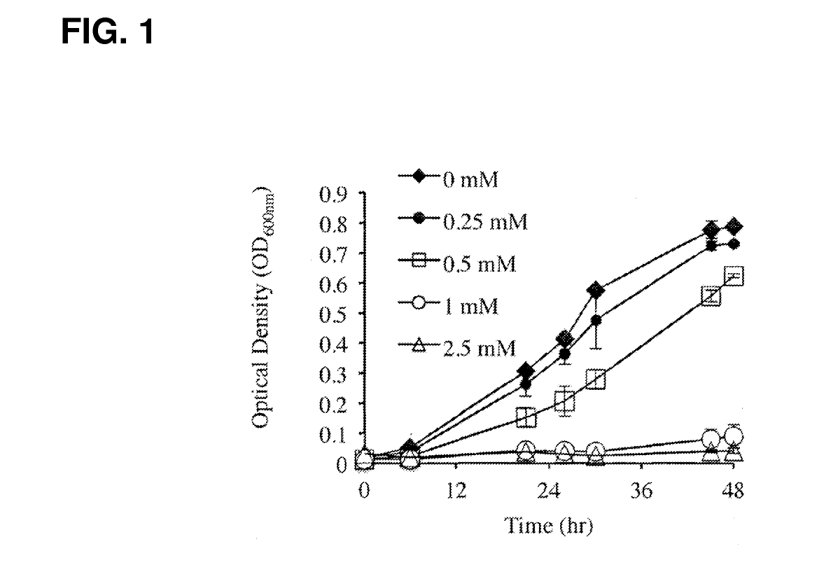

Previous studies demonstrated that the activity of the sulfate reducing organism Desulfovibrio desulfuricans (Hildenborough) was competitively inhibited by ammonium MFP ((NH₄)2PO₃F H₂O) at molar ratio of 2:5 (PO₃F²⁻: SO₄²⁻), and non-competitively inhibited at a molar ratio of 3:2 (PO₃F²⁻:SO₄²⁻) (Postgate, 1952). In contrast to the findings of Postgate, the findings presented herein have demonstrated that MFP is in fact a very potent specific inhibitor of sulfate reduction with limited impact on general microbial metabolism (FIG. 1 and Table 1). FIG. 1 demonstrates the ability of increasing concentrations of MFP to inhibit the growth of Desulfovibrio alaskensis G20 over time, and the concentrations of MFP that inhibited sulfate reduction in this organism were also calculated from this experiment. Indeed, in contrast to the findings of Postgate, the results demonstrate that MFP inhibits sulfate reduction at sub-millimolar concentrations even when sulfate concentrations are in the order of 30 mM. A concentration that inhibits 50% of sulfate reduction activity (IC₅₀ of sulfate reduction) was calculated for Desulfovibrio alaskensis G20, when grown on defined media, as being 100 μM. This data suggests some specificity for MFP to specifically inhibit sulfate reduction. To put this in perspective, IC₅₀ values were also determined for nitrate, the primary inhibitor currently under application for the control of souring in the oil industry. In this instance, the IC₅₀ value for nitrate against Desulfovibrio alaskensis G20 was 68 mM (680-fold higher than MFP).

As described above, various oxyanions have been explored as potential inhibitors of sulfate reduction. As seen in FIG. 1, low concentrations of MFP were able to inhibit the growth of the model sulfate reducer, Desulfovibrio alaskensis G20. Applicants performed similar experiments to investigate the potency of various other sulfate analogs at inhibiting the growth of Desulfovibrio alaskensis G20. It was found that other oxyanions or “sulfate analogs” have ranging potencies for inhibition of the growth of the model sulfate reducer, Desulfovibrio alaskensis G20 (Table 1).

TABLE 1
Characteristics of sulfate analogs and IC₅₀s (mM) against growth
of Desulfovibrio alaskensis G20 on lactate and sulfate media

| Ion | IC₅₀ | Putative target | Molecular charge |
|---|---|---|---|
| SO₄²⁻ | growth substrate | growth substrate | −2 |
| SO₃²⁻ | growth substrate | growth substrate | −2 |
| NO₃⁻ | 70.38 | SO₄²⁻ | −1 |
| | | reduction | |
| ClO₄⁻ | 23.23 | SO₄²⁻ | −1 |
| | | reduction | |
| ClO₃⁻ | 10.44 | SO₄²⁻ | −1 |
| | | reduction | |
| ClO₂⁻ | <1 mM | ox stress | −1 |
| IO₃⁻ | <1 mM | ox stress | −1 |
| BrO₃⁻ | <1 mM | ox stress | −1 |
| IO4− | <1 mM | ox stress | −1 |
| NO₂⁻ | 0.9254 | nit. Stress | −1 |
| MoO₄²⁻ | 0.0281 | SO₄²⁻ | −2 |
| | | reduction? | |
| WO₄²⁻ | 0.0633 | SO₄²⁻ | −2 |
| | | reduction? | |
| SeO₄²⁻ | 0.004 | SO₄²⁻ | −2 |
| | | reduction? | |
| HPO₃²⁻ | 276.6 | | −2 |
| FPO₃²⁻ | 1.217 | | −2 |

As can be seen in Table 1, in general, dianionic compounds such as molybdate, tungstate, selenate, and monofluorophosphate are more potent inhibitors of the growth of the model sulfate-reducing microorganism, Desulfovibrio alaskensis G20, than monocationic compounds such as nitrate, perchlorate, and chlorate. Phosphite and phosphate, though dicationic, are well-tolerated by this organism, as evident by the relatively high concentrations of HPO₃²⁻ needed to inhibit growth by 50%. Compounds such as iodate, periodate, bromate, chlorite, and to a lesser extent, nitrite, are reactive with metals, sulfide, and redox active proteins, and all have sub-millimolar IC₅₀ values (in terms of growth inhibition). This was evident in cultures of Desulfovibrio alaskensis G20, as these compounds reacted rapidly with sulfide present in the growth media and, without wishing to be bound by theory, are likely primarily toxic to bacteria through an oxidative stress mechanism.

The MFP inhibition results described above involved a single sulfate-reducing microorganism grown on defined media containing lactate and sulfate. To investigate the ability of MFP to specifically inhibit growth and/or sulfate reduction in sulfate-reducing microorganisms that are part of a more general microbial community in an undefined media, an additional experiment was conducted using marine sediments from seawater. Accordingly, for several compounds, IC₅₀ concentrations against growth and sulfide production for an undefined mixed marine community enrichment from San Francisco Bay were determined (Table 2).

TABLE 2
IC₅₀ (mM) of inhibitor against growth and sulfide production
in seawater adjusted to contain 2 g L⁻¹ yeast extract

| | IC₅₀ Seawater | IC₅₀ Seawater Sulfide | Growth/Sulfide |
|---|---|---|---|
| Inhibitor | Growth | Production | Ratio |
| NO₃⁻ | 261.8 | 6.339 | 41.3 |
| ClO₄⁻ | 36.34 | 3.248 | 11.19 |
| FPO₃⁻ | 55.58 | 0.8356 | 66.52 |
| NaF | >250 | 144.5 | N/A |

Similar to the results using MFP in defined media with a single sulfate-reducing microorganism, similarly low IC₅₀ values for MFP against an undefined sulfidogenic microbial community enriched from a marine sediment with yeast extract and sulfate were observed (Table 2). In this instance, for MFP an IC₅₀ value of ˜800 μM was observed. The impact of MFP was specific for SRM (sulfate-reducing microorganisms), as no impact was observed on general growth of the microbial community unless the MFP concentration was almost 70-fold higher (IC₅₀ of 55.58 mM) (Table 2). To put this in perspective, IC₅₀ values were also determined for nitrate which, as described above, is the primary inhibitor currently under application for the control of souring in the oil industry. In this instance, the IC₅₀ value for nitrate against the marine sediment enrichment was 6.34 mM (˜8-fold higher than MFP), indicating that MFP is a significantly more potent inhibitor of SRM activity than nitrate.

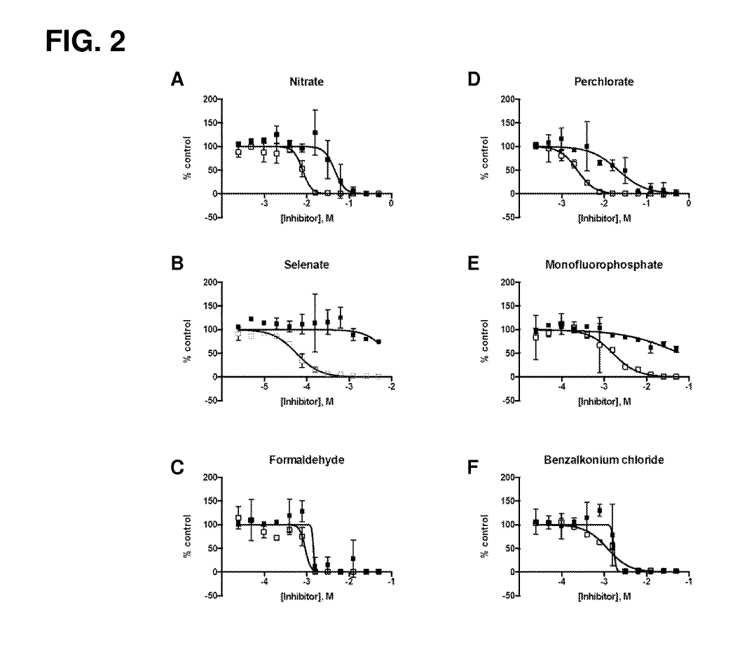

Applicants performed similar experiments to explore the action of additional oxyanion inhibitors against sulfate-reducing microorganisms that are part of a more general microbial community. For several additional compounds as those found in Table 2, IC₅₀ concentrations against both growth and sulfide production were compared for an undefined mixed marine community enrichment from San Francisco Bay (FIG. 2A-FIG. 2F). Investigation of these various compounds may provide insight into mechanisms of sulfate inhibition. In the case of nitrate and perchlorate, these compounds may function as alternative electron acceptors that, when present, are preferentially consumed over sulfate by the microbial community. Of the other sulfate analogs described in Table 1, only selenate and phosphite are confirmed as respiratory growth substrates. In contrast, compounds such as molybdate and monofluorophosphate are not electron acceptors or donors. As can be seen in FIG. 2E, the results again suggest that MFP is a specific inhibitor of sulfate reduction. The undefined microbial community was much more sensitive to MFP in terms of inhibition of sulfate reduction than in terms of inhibition of growth.

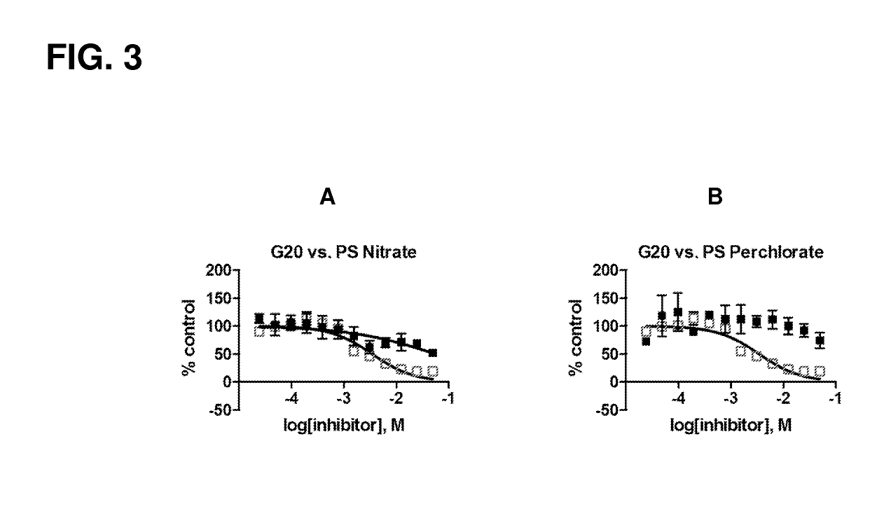

To further investigate the action of MFP as a sulfate-reduction specific inhibitor, the growth of a model perchlorate and nitrate reducing bacterium, Azospira suillum PS, was compared to the growth of the model sulfate-reducing microorganism Desulfovibrio alaskensis G20 in the presence of various concentrations of MFP while also using either perchlorate or nitrate as an electron acceptor. As can be seen in FIG. 3A and FIG. 3B, monofluorophosphate inhibits the growth of Desulfovibrio alaskensis G20 at concentrations below 1 mM, while Azospira suillum PS, growing in the same media, can tolerate concentrations of monofluorophosphate at least five times higher.

### Discussion

MFP is a highly soluble innocuous ion often used as an active ingredient in toothpaste, mouthwash, and a common additive to drinking water to offset tooth decay. Indeed, the widespread use of fluorophosphates-based toothpaste has been widely acknowledged to be the single most important factor contributing to the decline in dental caries (Cummins et al., 2013). As such, the application of MFP as a specific inhibitor of sulfidogenesis and souring control offers great potential as a cheap and effective solution to this deleterious process that should meet limited resistance from policy makers, engineers, and environmentalists. Further, dication monofluorophosphate salts (e.g. calcium monofluorophosphate, ferrous monofluorophosphate) are also likely more soluble than the corresponding phosphate salts, and are more similar to phosphite (PO₃²⁻) salts. This means that monofluorophosphate could be used in conjunction with metals or cations as a treatment strategy, or used in environments with high concentrations of these compounds.

### Example 2

### Temperature Control as a Means of Controlling Reservoir Souring

This Example describes the injection of heated fluid or a cooled fluid into an oil reservoir to increase or decrease, respectively, the temperature of the reservoir. As the fluid present in oil reservoirs during recovery processes represents potential biozones for sulfate-reducing microorganisms to produce hydrogen sulfide and increase souring of the reservoir, increasing or decreasing the temperature of these biozones to temperatures above or below those that permit hydrogen sulfide-producing metabolisms allows for the control of souring in the reservoir.

### Introduction

Reservoir souring is characterized by significant increases in hydrogen sulfide (H₂S) in production gas and fluids, typically after initiation of secondary recovery processes involving water injection. The souring potential of any reservoir is controlled by reservoir physical/chemical conditions. Oil exploration and reservoir development continue to occur in progressively deeper formations. Sedimentary basins have been explored to depths up to 7 km below the surface of Earth and many discoveries have occurred at depths of 1-4 km. At these depths, the in situ temperature may reach as high as 200° C. However, microorganisms, such as sulfate-reducing microorganisms that contribute to souring, are generally considered to have an upper temperature range of 125° C. Even so, only two organisms have been shown to be capable of survival and metabolism at temperatures as high as 121° C. As such, it is reasonable to assume that biosouring is unlikely to be an issue in reservoirs with intrinsic temperatures exceeding 125° C. However, during oil recovery, injection of large volumes of seawater at an ambient temperature of ˜4° C. results in significant heat loss from the reservoir, creating temperature gradients across the flooded reservoir volume between the injection-producing well pair. As such, conditions conducive to microbial metabolism are created in the cooled matrix, with the resultant biogenesis of H₂S. Applicants describe herein a method of heating injection waters to increase or decrease the temperature of the reservoir such that sulfate-reducing metabolism in microorganisms cannot be supported, resulting in reduced souring of the reservoir.

### Results

An oil reservoir is selected that is suitable for secondary oil recovery procedures. This oil reservoir will be injected with heated or cooled seawater to both assist with oil recovery and to increase or decrease, respectively, the temperature of the reservoir to decrease hydrogen sulfide production and associated reservoir souring.

As described above, oil reservoirs may be injected with seawater during secondary oil recovery processes, but this seawater typically has an ambient temperature of ˜4° C., resulting in significant heat loss from the oil reservoir as the injection waters travel through the reservoir. The extent of this heat loss and the resulting temperature gradient across that is established across the reservoir is a function of the volume of water injected and the temperature difference between the injected water and the internal temperature of the reservoir without injection waters. The rate of heat loss is a function of the rate of water injection for any set temperature differential, which ultimately determines the steepness of the temperature gradient across the reservoir. If relative fluid injection rates are low, the temperature gradient will be steep and only a small volume of the reservoir around the injection well will be impacted, limiting the potential for biosouring to within this zone (biozone). However, if injection rates are relatively large, the temperature gradient can extend across the entire reservoir from injector to producer, resulting in a decrease in the overall reservoir temperatures and allowing for biosouring throughout the flooded volume. Minimization of the biozone is optimal for the minimization of souring potential.

To reduce the size of the biozone, the seawater to be injected into the oil reservoir is heated. Heating of injected waters to reduce heat loss from the system and thus reduce the biozone can be achieved through engineered heat recovery from hot produced reservoir fluids in addition to heat available through the combustion of produced natural gases. As the reservoir matures, the total heat energy input required is reduced as the majority of the produced hot waters are recycled, thus only the makeup water requires temperature elevation from ambient sea temperatures to the reservoir temperature. Ideally, for hot reservoirs (>121° C.), injection water temperatures would be maintained at values equal to the reservoir temperature. Every increase in injected water temperature will result in a decrease in the size of the biozone.

Alternatively, to reduce the size of the biozone, the seawater to be injected into the oil reservoir is cooled. Cooling of injected waters to cool the system to temperatures below those that are capable of supporting sulfate-reducing metabolism and thus reduce the biozone can be achieved through methods known in the art. Ideally, the cooled fluid should be injected into the reservoir at a temperature below 0° C. Every decrease in injected water temperature will result in a decrease in the size of the biozone.

After heated seawater or cooled seawater is injected into the oil reservoir, the reservoir is monitored for signs of souring, microbial life, and/or evidence of sulfate-reducing metabolism. This method of injecting heated or cooled fluid into an oil reservoir is evaluated in comparison to the development of souring in a comparable oil reservoir that is injected with seawater at ambient temperature by monitoring the evolution of a sulfate-reducing microbial community, by monitoring the depletion of sulfate in the produced fluids, by monitoring an alteration of the stable isotopic fingerprint of sulfur and oxygen species in sulfate in the produced fluids, or by monitoring the production of sulfide.

Assays demonstrating the use of heated fluids or cooled fluids to reduce biozones can also be performed at lab scale using columns.

### Example 3

### Integrative Souring Control Using Chemical and Physical Treatment of Oil Reservoirs

This Example describes the injection of heated fluid containing monofluorophosphate or cooled fluid containing monofluorophosphate into an oil reservoir to increase the temperature of the reservoir. This combination approach may be used to control souring in the oil reservoir.

As seen in Example 1, it was demonstrated that monofluorophosphate is a specific inhibitor of sulfate-reducing microorganisms. As seen in Example 2, it is demonstrated that injection of heated fluid or a cooled fluid into an oil reservoir can be used to increase or decrease, respectively, the temperature of the oil reservoir such that sulfate-reducing microorganisms cannot grow and/or produce hydrogen sulfide. Without wishing to be bound by theory, it is thought that the addition of a chemical inhibitor of sulfate-reducing microorganisms, such as monofluorophosphate, into a heated fluid or into a cooled fluid for injection into an oil reservoir, as described in Example 2, may further decrease souring in the reservoir as compared to either the chemical or physical (e.g. heated or cooled fluid) treatment alone.

To investigate this, an oil reservoir is selected that is suitable for secondary oil recovery procedures. This oil reservoir will be treated using a combination chemical and physical approach to both assist with oil recovery and to aid in decreasing hydrogen sulfide production and associated reservoir souring.

Monofluorophosphate is added to the seawater to be injected into the oil reservoir to arrive at a final concentration of 0.8 mM. Following the addition of monofluorophosphate, the seawater is heated. Alternatively, following the addition of monofluorophosphate, the seawater is cooled.

After the monofluorophosphate-containing heated or cooled seawater is injected into the oil reservoir, the reservoir is monitored for signs of souring, microbial life, and/or evidence of sulfate-reducing metabolism. This method of injecting monofluorophosphate-containing heated fluid or monofluorophosphate-containing cooled fluid into an oil reservoir is evaluated in comparison to the development of souring in a comparable oil reservoir that is injected with seawater at ambient temperature.

The combinatorial method for controlling souring as described in this Example may include chemical inhibitors of souring other than monofluorophosphate, or may further include other chemical inhibitors in addition to monofluorophosphate. For example, nitrate and/or (per)chlorate may be used in place of or in addition to monofluorophosphate in the combination approach.

### Example 4

### Monofluorophosphate is a Selective Inhibitor of Respiratory Sulfate-Reducing Microorganisms

This Example elaborates upon the information and data presented in Example 1, in which Applicants demonstrated that monofluorophosphate acted as a selective inhibitor of sulfate-reducing microorganisms.

Despite the environmental and economic cost of microbial sulfidogenesis in industrial operations, few compounds are known as selective inhibitors of respiratory sulfate reducing microorganisms (SRM), and no study has systematically and quantitatively evaluated the selectivity and potency of SRM inhibitors. Using high-throughput assays to quantitatively evaluate inhibitor potency and selectivity in a model sulfate-reducing microbial ecosystem, as well as inhibitor specificity for the sulfate reduction pathway in a model SRM, Applicants screened a panel of inorganic oxyanions. Applicants identified several SRM selective inhibitors including selenate, selenite, tellurate, tellurite, nitrate, nitrite, perchlorate, chlorate, monofluorophosphate, vanadate, molybdate, and tungstate. Monofluorophosphate (MFP) was not known previously as a selective SRM inhibitor, but has promising characteristics including low toxicity to eukaryotic organisms, high stability at circumneutral pH, utility as an abiotic corrosion inhibitor, and low cost. MFP remains a potent inhibitor of SRM growing by fermentation, and MFP is tolerated by nitrate and perchlorate reducing microorganisms. For SRM inhibition, MFP is synergistic with nitrite and chlorite, and could enhance the efficacy of nitrate or perchlorate treatments. Finally, MFP inhibition is multifaceted. Both inhibition of the central sulfate reduction pathway and release of cytoplasmic fluoride ion are implicated in the mechanism of MFP toxicity.

### Introduction

In diverse industrial ecosystems, hydrogen sulfide (H₂S) production by sulfate reducing microorganisms (SRM) is environmentally and economically costly.¹ H₂S is toxic, explosive, and corrosive. It is a primary cause of pipeline leaks, and a major inhalation hazard for workers in hydrocarbon recovery and municipal wastewater operations.^{1,2} An understanding of the environmental controls on SRM and new treatments to prevent sulfidogenesis could save lives and prevent loss of biodiversity in fragile ecosystems.

While some specific inhibitors of sulfidogenesis are used in industrial ecosystems (e.g., oil reservoirs),²⁻⁴ most treatment options are nonspecific biocides.⁵ A nonspecific inhibitor of microbial growth may drive the emergence of resistant populations or, upon cessation of treatment, regrowth of a microbial community dominated by the most abundant microorganisms, which are likely SRM in sulfidogenic systems. The use of inorganic oxyanions that act as inhibitors of sulfate respiration is a popular approach to achieving specific inhibition of SRM.^{2,6} In oil recovery systems, nitrate injection is the most popular treatment.⁶ Nitrate inhibits SRM through a variety of mechanisms,^{2,7-10} and Applicants have recently shown that nitrate is a direct, specific inhibitor of sulfidogenesis and SRM growth in microbial communities.¹¹ Perchlorate and chlorate, collectively (per)chlorate, represent attractive alternatives to nitrate as selective inhibitors of sulfide production.^{3,11-13} In microbial communities, both nitrate and (per)chlorate can inhibit SRM through biocompetitive exclusion and outgrowth of nitrate-reducing microorganisms (NRM) and perchlorate-reducing microorganisms (PRM), sulfide reoxidation by NRM⁷ and PRM,¹³ and direct inhibition of SRM by these compounds.¹¹

Molybdate is a widely used inhibitor of sulfate reduction in microbial ecology studies, and occasionally is used to treat sulfidogenesis in oil reservoirs. In contrast to the competitive inhibitors nitrate and (per)chlorate, molybdate is a substrate for ATP sulfurylase/sulfate adenosyltransferase (Sat) enzymes.¹⁴⁻¹⁸ The product of the Sat-catalyzed reaction between sulfate and ATP is adenosine 5′-phosphosulfate (APS), but the product of the enzymatic reaction between molybdate and ATP is adenosine 5′-phosphomolybdate (APMo), which is unstable and rapidly decomposes. This drives a futile cycle that consumes cytoplasmic ATP.¹⁴⁻¹⁸ This futile cycle also occurs with tungstate and chromate,¹⁷ and is thought to be the central mechanism of inhibition of sulfate-reducing microorganisms by these compounds. In support of this, molybdate does not compete with sulfate uptake by a representative Desulfovibrio culture,¹⁹ and Desulfovibrio cell suspensions treated with molybdate for 60 min had intracellular ATP concentrations ˜10% that of untreated controls.²⁰ In contrast, molybdate treated cell suspensions of nitrate reducing bacteria, which lack Sat, had ˜80% the intracellular ATP levels of controls.²⁰ Finally, it has been demonstrated that appropriate doses of molybdate specifically inhibit sulfate reduction, but not methanogenesis, in marine sediments.²¹

From studies with the eukaryotic ATP sulfurylases, inorganic oxyanions have been generally classified as competitive inhibitors of sulfate binding and activation (e.g., perchlorate, chlorate, nitrate, thiosulfate, and fluorosulfate) or ATP-consuming futile substrates (e.g., molybdate, arsenate, chromate, tungstate, selenate, and monofluorophosphate).¹⁴⁻¹⁶

Depending on the stability of the APS analogs, the rate and extent of the ATP consuming futile cycle will vary. The molybdate, tungstate, arsenate and chromate analogs are all very unstable, while adenosine 5′-phosphoselenate has a half-life on the order of 15 min. In contrast, the product of the ATP sulfurylase reaction between ATP and MFP, adenosine 5′-(2-fluorodiphosphate) (ADPβF), is more stable than APS, and is apparently a better APS analog than ADP analog, suggesting that it may also interfere with downstream steps in the sulfate assimilation or reduction pathways.²²

Although informative about the mechanism of inhibition, studies with purified proteins or pure cultures do not evaluate the selectivity of inhibitors. No study has systematically evaluated the potency and selectivity of inorganic oxyanions as SRM inhibitors. Thus, potent and selective inhibitors may have been overlooked. Applicants developed a high-throughput screening strategy to systematically assess both the specificity and potency of compounds for inhibition of sulfidogenesis in the context of a marine microbial community. Applicants evaluated a panel of sulfate analogs and have demonstrated for the first time that monofluorophosphate (FPO₃²⁻, MFP) is a potent and selective inhibitor of respiratory sulfate reduction in environmental communities. MFP is synergistic with nitrite and chlorite, and less inhibitory of nitrate and perchlorate reducing organisms than SRM, suggesting that MFP could be used in combination with these compounds. Finally, Applicants obtained preliminary insights into the mechanism of inhibition of a model SRM by MFP, and considerations for the use of MFP as an industrial inhibitor of sulfidogenesis are presented.

### Materials and Methods

Media and Cultivation Conditions

Desulfovibrio alaskensis G20 was cultivated in anoxic basal Tris-buffered lactate/sulfate media, pH 7.4 at 30° C. The media contained 8 mM MgCl₂, 20 mM NH₄Cl, 0.6 mM CaCl₂, 2 mM KH₂PO₄, 0.06 mM FeCl₂, and 30 mM Tris-HC1. 60 mM sodium lactate and 30 mM sodium sulfate were added. Trace elements and vitamins were added from stocks according to a previously published recipe.^{23,24} Desulfovibrio alaskensis G20 was recovered from 1 mL freezer stocks in 10 mL anoxic basal media in Hungate tubes (Hungate tubes, Bellco, Vineland, N.J., U.S.A.) with 1 g/L yeast extract and 1 mM sodium sulfide and washed in basal media to remove residual yeast extract prior to inoculation of microplates or tubes for experiments.

Marine enrichment cultures were passaged anoxic planktonic communities from continuous flow reactor columns inoculated from marine sediments collected from San Francisco Bay.¹² 2 g/ L yeast extract was added to Instant Ocean (Thermo Fisher Scientific, Waltham, Mass., U.S.A.) marine mix (35 g/L) to make seawater media and enrichments were grown anoxically at 30° C. in Hungate tubes. Enrichments were stored as −80° C. glycerol stocks, recovered in seawater media, and washed before inoculation of cultures for experiments.

For IC₅₀ determinations, microplates were inoculated in an anaerobic chamber (Coy) with cultures at an initial OD 600 of 0.02. Desulfovibrio and marine enrichment cultures were cultivated in both 96 well microplates (Costar, Thermo Fisher Scientific, Waltham, Mass., U.S.A.) and 384 well microplates (Nunc, Thermo Fisher Scientific, Waltham, Mass., U.S.A.) with plate seals (Thermo Fisher Scientific, Waltham, Mass., U.S.A.). The sealed plates were kept in anoxic BD GasPak anaerobic boxes except when time points were being recorded (BD, Franklin Lakes, N.J., U.S.A.). IC₅₀s against growth were determined at 48 h for sulfate reducing G20 or 36 h for sulfite reducing or pyruvate fermenting G20. IC₅₀s against growth and sulfidogenesis were determined at 48 h.

All inorganic oxyanions were sodium salts (Sigma-Aldrich, St. Louis, Mo., U.S.A.). Data analysis for inhibition experiments was carried out in GraphPad Prism 6 (GraphPad Software, Inc., La Jolla, Calif., U.S.A.) and curves were fit to a standard inhibition log dose-response curve to generate IC₅₀ values. 95% confidence intervals are reported. All IC₅₀s are the mean of at least three biological replicates. Synergy was assessed using the equation for Fractional Inhibitory Concentration Index (FICI).²⁵

16S rRNA Gene Amplicon Sequencing of Marine Enrichment Cultures

For 16S rRNA gene amplicon sequencing, marine enrichment cultures were grown in 96-well plates in the presence of 2-fold serial dilutions of nitrate or perchlorate (gradient plates). The gradient plate cultures were inoculated at an initial OD 600 of 0.02 in a volume of 200 μL. After 48 h (OD 600 of 0.3-0.4), cultures were harvested by centrifugation, 180 μL supernatant was removed, and genomic DNA was extracted from the remaining pellet and the V3 V4 region of the 16S rRNA gene was amplified using unique dual indexed primers with attached Illumina adaptors, similar to previously published primers,^{26,27} and sequenced using the 600 bp MiSEQ V3 kit (Illumina, San Diego, Calif., USA). Reads were analyzed by a combination of custom scripts, PEAR28 and the QIIME pipeline.²⁹

qPCR Assay for Quantifying dsrA

DNA was pooled from 4 replicate 96-well gradient plates (˜800 μL of culture) and Taqman (Life Technologies, Grand Island, N.Y., USA) qPCR was used to quantify dsrA gene abundance using previous methods with some modifications.^{30,31}

### Results

Evaluating the Potency and Selectivity of Monomeric Inorganic Oxyanions for Inhibition of Sulfidogenesis in Complex Microbial Communities

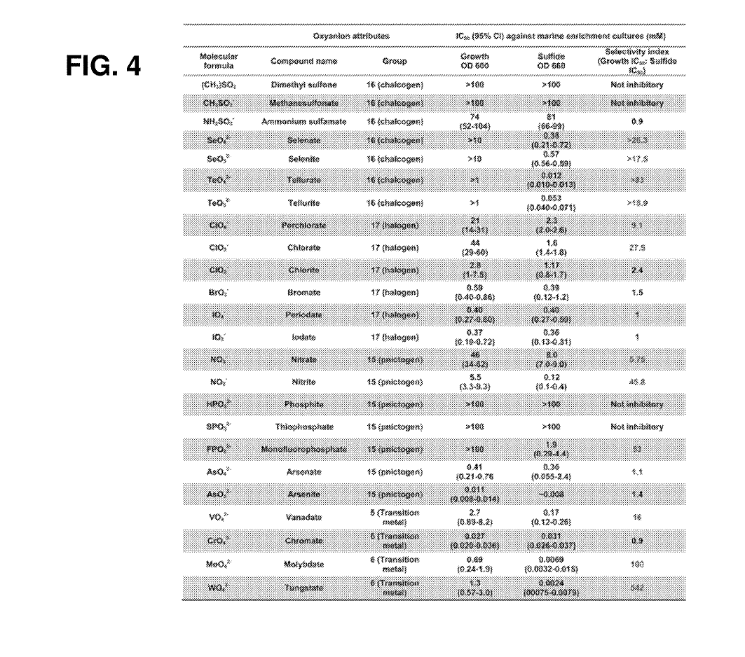

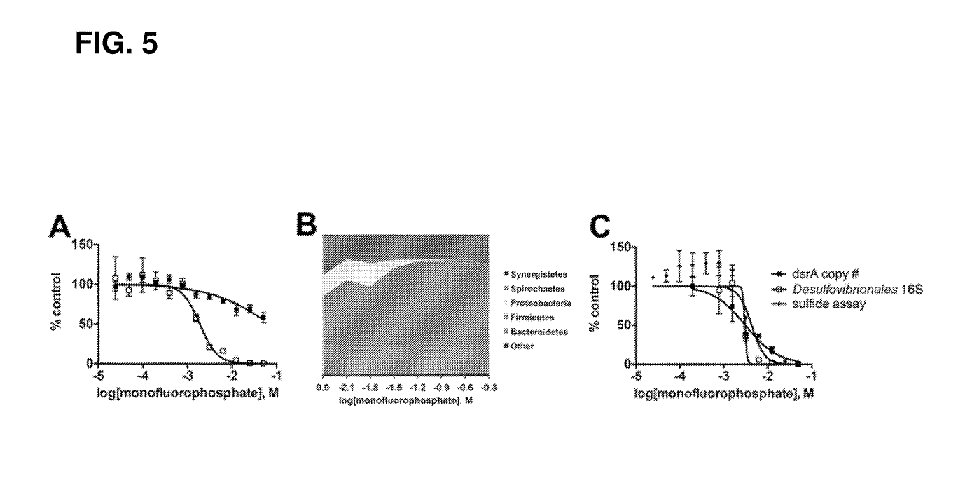

Serial dilutions of compounds in microplates were prepared. The plates were inoculated with a sulfidogenic marine enrichment culture¹¹ amended with the complex electron donor, yeast extract (2 g/L), to ensure maintenance of a phenotypically and phylogenetically diverse community membership with sulfate as the sole electron acceptor. By comparing the IC₅₀s against growth as measured by OD 600 with the IC₅₀s against sulfide production as measured by the colorimetric Cline assay, compounds were identified that were selective inhibitors of sulfidogenesis versus growth (FIG. 4 and FIG. 5). A panel of inorganic oxyanion analogs was evaluated using this assay (FIG. 4) and selectivity indices (SI) were calculated (SI=growth IC₅₀/sulfide IC₅₀). Compounds with SI>2 were classified as selective inhibitors of sulfidogenesis in the marine enrichment, and it was confirmed that the growth and sulfide IC₅₀s were different using ANOVA. This approach could be adapted to a variety of microbial systems and allows quantification of both the inhibitory potency and selectivity of compounds against sulfidogenic populations.

Transition Metal Oxyanions

Of the transition metal oxyanions, chromate was nonspecific, but vanadate, molybdate, and tungstate were specific inhibitors of sulfide production (FIG. 4). The selectivity indices for molybdate (SI=100) and tungstate (SI=589) were among the highest for the panel of compounds that were screened, but concentrations above 1 mM inhibited all growth in the marine enrichment cultures. In some studies, concentrations in the range of 1-100 mM have been used to inhibit sulfidogenesis in environmental systems.^{21,32} On the basis of the results presented herein (FIG. 4), the application of lower concentrations may have yielded different results in these previous studies (e.g., higher methane titers or higher growth yields of other non-SRM). Applicants believe that this is the first observation of selective inhibition of SRM by vanadate.

Chalcogen (Group 16) Oxyanions

Both sulfate and sulfite are growth substrates for sulfate reduction and only inhibited growth and sulfidogenesis at high millimolar concentrations. The substituted sulfate analogs ammonium sulfamate, methanesulfonate, and dimethyl sulfone were all very weak and nonspecific inhibitors (FIG. 4). In contrast, selenate, selenite, tellurate, and tellurite were very potent and selective inhibitors of sulfate reduction (FIG. 4). Both selenate and tellurate are isoelectronic with sulfate and are known to be toxic and reduced by SRM and other bacteria.^{33,34} In the cultures used herein, at high concentrations of the selenium and tellurium oxyanions, visual color changes and precipitates were observed, consistent with reduction of these compounds. Although fluorosulfate and thiosulfate are competitive inhibitors of the yeast ATP sulfurylase,¹⁶ these compounds were not tested for logistical reasons. Fluorosulfate decomposes in water into the toxic compounds sulfuric acid and hydrogen fluoride, while thiosulfate is a growth substrate for many SRM.

Halogen (Group 17) Oxyanions

Of the halogen oxyanions, only perchlorate and chlorate, collectively (per)chlorate, were selective inhibitors of sulfidogenesis (FIG. 4). While (per)chlorate were less potent inhibitors of sulfidogenesis compared to the other selective inhibitors identified, they were the only monoanionic compounds that were selective inhibitors. Previously, Applicants demonstrated that nitrate, perchlorate, and chlorate were not reduced in marine enrichments,¹¹ implying that the effect of these compounds is direct and not due to outgrowth of respiratory (per)chlorate reducing microorganisms. Bromate, iodate, and periodate were also nonspecific, but potent inhibitors of all growth in marine enrichment cultures. Bromine and iodine oxyanions are strong oxidizing agents that rapidly react with sulfide, Fe(II) minerals, and cellular components.

Pnictogen (Group 15) Oxyanions

Of the pnictogen oxyanions, nitrate, nitrite, and monofluorophosphate were selective inhibitors. Nitrate was the least potent of the selective inhibitors in the panel tested, and nitrite was only weakly selective (SI≈2). In contrast to monofluorophosphate, the other phosphate derivatives, thiophosphate and phosphite, were weak inhibitors and nonselective. Arsenate was not selective, likely because it interferes with phosphate metabolism in all organisms in the enrichment.

16S Amplicon Sequencing and dsrA qPCR to Confirm Selectivity of Monofluorophosphate against Growth of SRM

In the marine enrichment cultures, MFP inhibited sulfidogenesis with an IC₅₀=1.9 (0.29-4.4) mM, but the growth IC₅₀ was greater than 100 mM (FIG. 4, FIG. 5A). The selective inhibition by MFP (SI=53) could potentially shift a facultative SRM population to fermentative or syntrophic growth coupled to methanogenesis. However, in the marine enrichment culture tested herein, Desulfovibrionales was the only proteobacterial genus observed and 16S amplicon sequencing of cultures grown in varying concentrations of MFP revealed dramatic depletion of proteobacteria (dominated by Desulfovibrionales) at concentrations above the sulfide IC₅₀ with little change in the relative abundances of other phyla (FIG. 5B). Furthermore, the IC₅₀ values for MFP against sulfidogenesis, Desulfovibrionales abundance, and abundance of the dsrA gene copy number were identical (FIG. 5C), indicating that the SRM do not persist and grow during MFP treatment by using alternative metabolisms.

Resistance of a Nitrate and Perchlorate Respiring Microorganism to Monofluorophosphate

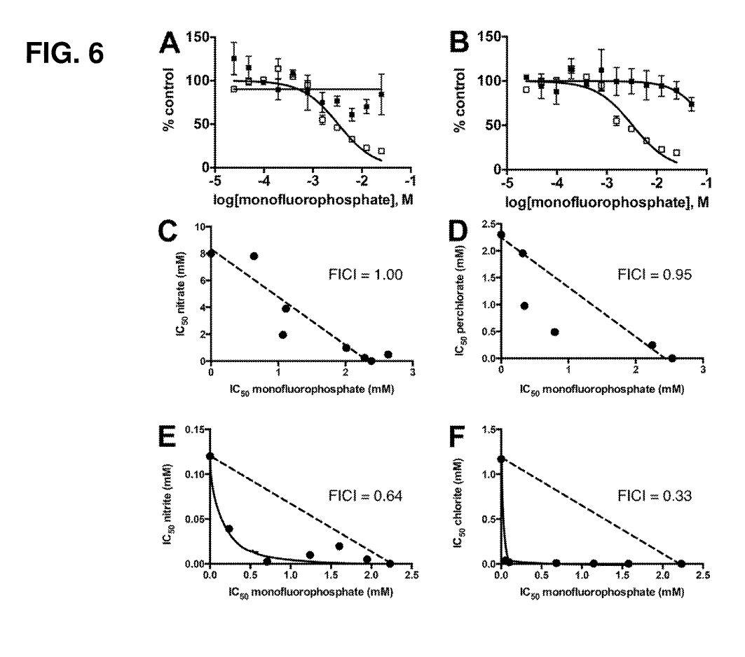

At present, the dominant strategy to combat sulfidogenesis in industrial ecosystems is nitrate treatment.² Perchlorate treatment is a promising alternative,^{12,13} and Applicants have previously demonstrated its greater potency and selectivity against SRM.^{11,12} These two treatments may rely, in part, on the activity of NRM and PRM, and thus, Applicants sought to evaluate whether or not MFP was inhibitory of these organisms and could be used as an additive or synergistic treatment during nitrate or perchlorate injection. Azospira suillum PS, a model organism capable of both nitrate and (per)chlorate respiration,³⁵ was grown in the presence of varying concentrations of MFP (FIG. 6). MFP inhibited the growth of Desulfovibrio alaskensis G20 with an IC₅₀ of 1.2 (0.88-1.6) mM, while A. suillum PS grown under either nitrate or perchlorate-reducing conditions tolerated much higher concentrations (IC₅₀>50 mM) (FIG. 6A and FIG. 6B).

Synergistic Inhibition of Sulfidogenesis by Nitrite or Chlorite and Monofluorophosphate

Synergistic SRM inhibitors can decrease the inhibitory concentrations needed to treat sulfidogenesis.⁴ In drug combinations, synergy can increase not only the potency, but also the selectivity of compounds.³⁶ Therefore, synergistic combinations could be used in treating sulfidogenesis in industrial systems at lower cost and with greater efficacy. The potential for synergy between MFP and nitrate, perchlorate, nitrite, and chlorite in inhibition of sulfidogenesis in the marine enrichment culture was therefore evaluated. Synergy was assessed using the equation for Fractional Inhibitory Concentration Index (FICI) based on the IC₅₀ for each inhibitor A and B in the absence or presence of the other inhibitor. Combinations of MFP with nitrate (FICI=1) or perchlorate (FICI=0.95) were additive indicating no synergistic impact (FIG. 6C and FIG. 6D). In contrast, combinations of MFP with nitrite (FICI=0.3) or chlorite (FICI=0.06) were highly synergistic (FIG. 6E and FIG. 6F). Together with the observation that MFP is only weakly inhibitory of nitrate and perchlorate reducing bacteria (FIG. 6A and FIG. 6B), this result suggests that in a stratified system in which nitrate or perchlorate reduction (and potentially nitrite and chlorite accumulation) spatially precede sulfate reduction, synergistic inhibition of SRM could occur through combined nitrate or perchlorate and MFP amendments. It is proposed that biogenic nitrite is the most important inhibitor of sulfate reduction produced in nitrate treated oil reservoirs, but this has not been conclusively demonstrated.² Thus, evaluating the potential for MFP synergy with nitrate or perchlorate amendments could be a powerful diagnostic tool to understand whether inhibition in a complex community is due to the parent ions or the reactive respiratory intermediates.

Potency of Inorganic Oxyanions for Inhibition of Desulfovibrio alaskensis G20 Wild-Type and tn5::rex Mutant

To gain insights into the mechanism of inhibition of a model SRM by the panel of inorganic oxyanions, several assays with D. alaskensis G20 were conducted. First, the inhibitory potencies against wild-type D. alaskensis G20 and against a tn5::rex mutant strain that overproduces the central pathway of sulfate reduction were compared.³⁷ In particular, the tn5::rex strain overproduces the core Rex regulon consisting of qmoABCD (Dde_1111:Dde_1114), sat (Dde_2265), adenylate kinase (Dde_2028), pyrophosphatase (Dde_1178), a sulfate transporter (Dde_2406), an ATP synthase, atpFFHAGD (Dde_0990:Dde_0984), and atpIIBE (Dde_2698:Dde_2701).³⁷ Compounds that target the enzymes in the core Rex regulon may be more or less inhibitory to tn5::rex than to wild-type G20. Previously, Applicants and others have demonstrated that Rex mutants are resistant to competitive inhibitors of sulfate reduction including nitrate^{11,38} and (per)chlorate,¹¹ which strongly suggests that these compounds directly target the sulfate reduction pathway in D. alaskensis G20.

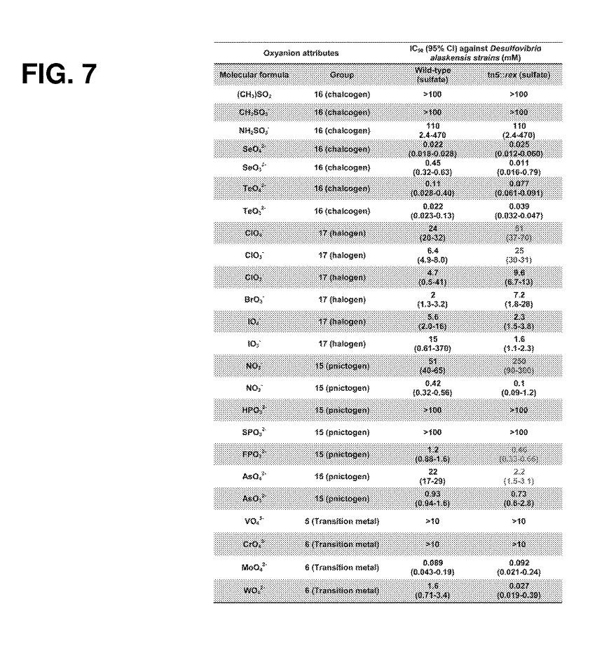

Strikingly, in the panel of compounds tested, Rex mutants were only resistant to nitrate and (per)chlorate, which are the only confirmed competitive inhibitors of eukaryotic ATP sulfurylase¹⁶ that were tested (FIG. 7). Rex mutants were only sensitive to MFP and arsenate (FIG. 7). While overproduction of sulfate reduction enzymes may overcome competitive inhibition, noncompetitive inhibitors or alternative/futile substrates of the ATP sulfurylase (e.g., molybdate, tungstate, chromate, arsenate, selenate, and monofluorophosphate) are likely to be equally or slightly more potent inhibitors of Rex mutants. For example, Rex mutants express higher levels of sulfate transporters, and are therefore equally if not more permeable to these toxic compounds. Higher levels of Sat may also catalyze more nonproductive catalysis by futile/alternative substrates and more rapidly consume ATP pools in Rex mutants.

Arsenate was not selective against sulfidogenesis in the marine enrichment cultures, likely because it functions as a toxic phosphate mimic in all organisms. However, arsenate is a more potent inhibitor of Rex mutants than wild-type G20 (FIG. 7). Arsenate is believed to enter D. alaskensis G20 through sulfate transporters,³⁹ and higher levels of the transporters in Rex mutants might lead to higher intracellular arsenate concentrations that could overwhelm the G20 arsenate detoxification mechanisms.³⁹ Arsenate is also a futile substrate for ATP sulfurylase in eukaryotes¹⁶ and may function similarly in G20. The sensitivity of Rex mutants to MFP may be through a similar mechanism. More MFP may be transported into the cytoplasm by Rex mutants and intracellular MFP may be the active inhibitor. Also, MFP could potentially be converted into other inhibitory compounds, (e.g., ATPβF, F⁻) by components of the sulfate reduction pathway. Molybdate and tungstate were equally potent inhibitors of Rex mutants and wild-type cells. This is consistent with molybdate and tungstate functioning as alternative substrates for ATP sulfurylases.^{14,16,17} Competitive inhibition of Dsr by nitrite⁴⁰ would likely similarly impact wild- type G20 and Rex mutants, as Dsr is not upregulated in Rex mutants.³⁷

Potency of Selected Inorganic Oxyanions for Inhibition of G20 Growth under Fermentative and Sulfite-Reducing Conditions

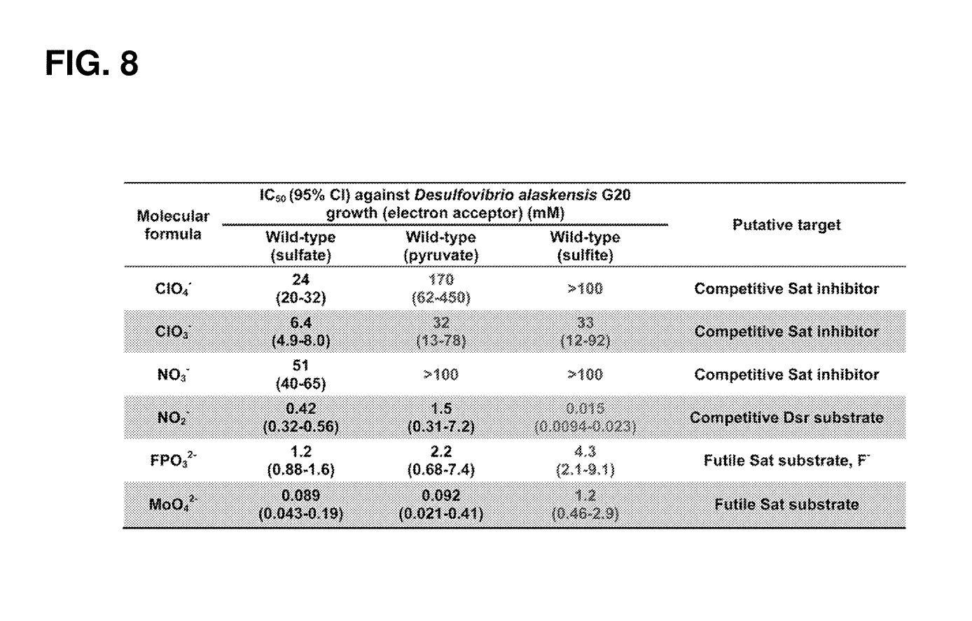

In the marine enrichment cultures, 16S amplicon sequencing and dsrA qPCR analyses indicate that the sulfidogenic Desulfovibrionales did not switch to fermentative or syntrophic growth in the presence of MFP (FIG. 5) nitrate or perchlorate.¹¹ However, because the capacity for fermentative growth could theoretically confer resistance of SRM to sulfate reduction specific inhibitors, the inhibitory potency of selected inorganic oxyanions against D. alaskensis G20 growing by pyruvate fermentation was evaluated (FIG. 8). Furthermore, D. alaskensis G20 apparently upregulates the central pathway of sulfate reduction under pyruvate fermenting conditions relative to sulfate reducing conditions.⁴¹ Thus, as with Rex mutants, compounds that target sulfate reduction could have altered potencies against pyruvate fermenting cells. Of the compounds tested, only the competitive inhibitors, nitrate and (per)chlorate, were less potent inhibitors of pyruvate grown G20 than lactate/sulfate grown G20. In contrast, the other selective inhibitors of sulfate reduction from the marine enrichment cultures (FIG. 4) were equally potent inhibitors of pyruvate fermenting G20. This observation has implications for choosing an inhibitor to apply to an environmental or industrial setting. In a system with varying fluxes of sulfate, SRM may shift to a fermentative lifestyle. A competitive inhibitor of sulfate reduction would be less effective at preventing SRM growth by fermentation, but compounds such as MFP may retain efficacy.

Comparison of the inhibitory potency of compounds against sulfate reduction versus sulfite reduction can distinguish compounds that target sulfate transport, sulfate activation, and APS reduction from compounds that target sulfite reduction.⁴² It was observed that several compounds proposed to target sulfate reduction including nitrate, (per)chlorate, monofluorophosphate, and molybdate were less inhibitory to sulfite grown cells than sulfate grown cells (FIG. 8). In contrast, nitrite was more inhibitory of sulfite reduction, and is known to be a competitive/alternative substrate of the dissimilatory sulfite reductase, Dsr.⁴⁰ Although nitrite toxicity has been studied in D. vulgaris Hildenborough, this organism possesses an NrfA, nitrite reductase, and detoxification systems for reactive nitrogen species (RNS).^{8,43} Therefore, the only phenotypes associated with nitrite resistance were for mutants in RNS resistance proteins, and evaluating the true cellular target(s) of nitrite inhibition has been difficult. Applicant's observation that nitrite is a more potent inhibitor of sulfite reduction relative to sulfate reduction by D. alaskensis G20 (FIG. 8) is the first clear evidence that Dsr inhibition is implicated in nitrite toxicity in an SRM.

Fluoride Ion Toxicity Is Associated with MFP Toxicity

Little is known about the mechanism of inhibition of SRM by MFP aside from the observation that it is competitive inhibitor of sulfate reduction at low concentrations but noncompetitive at higher concentrations³ and the observation that MFP is an alternative substrate for ATP sulfurylases from eukaryotes.¹⁶ Insight can be gained into the mechanism of SRM inhibition by comparing the inhibitory potency and selectivity of MFP against growth and sulfidogenesis in marine enrichments with the closely related compounds phosphite and thiophosphate. Although these compounds have similar ionic radii and charge state at neutral pH and are stable to hydrolysis, these other phosphate analogs were very weak, nonselective inhibitors of sulfidogenesis. This implies a unique structural feature of the intact MFP ion or toxicity associated with F⁻ release.

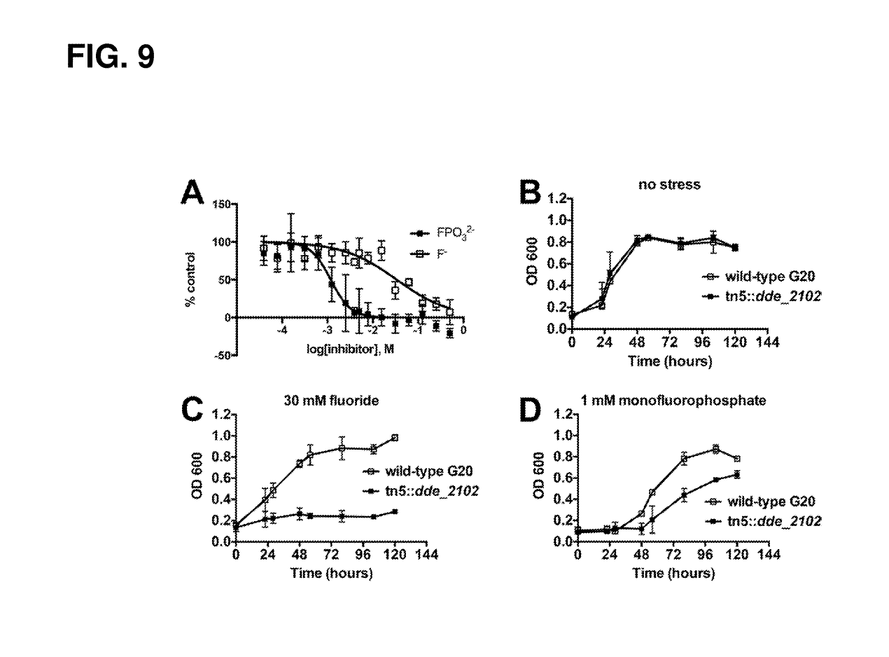

Applicants sought to evaluate the role of F⁻ in the mechanism of MFP toxicity. While MFP has an IC₅₀=1.2 (0.88-1.6) mM against D. alaskensis G20, fluoride ion has an IC₅₀ of 34 (21-54) mM (FIG. 9A). Fluoride ion is highly toxic to microbial cells, but generally higher concentrations are inhibitory because fluoride only traverses cell membranes as HF.⁴⁴ Recently, a class of fluoride specific efflux pumps, crcB, has been identified in diverse bacteria, further emphasizing the importance of developing resistance mechanisms to F⁻. In D. alaskensis G20, the fluoride efflux pump (CrcB) homologue is Dde_2102. The tn5::dde_2102 strain was grown in the presence of 30 mM F⁻ or 1 mM MFP, and it was observed that relative to wild-type G20, this mutant strain grew well in the absence of stress, but was sensitive to F⁻ and MFP (FIG. 9A-9D). Because the fluoride efflux pump is involved in the efflux of cytoplasmic fluoride ion, this result confirms that cytoplasmic fluoride is present in D. alaskensis G20 cells treated with MFP, and is strong evidence that intracellular MFP hydrolysis occurs in D. alaskensis G20 and contributes to the mechanism of inhibition.

### Discussion

Applicants have quantitatively compared the potency and selectivity of a panel of inorganic oxyanions as inhibitors of sulfate reduction in a marine enrichment culture. In screens with D. alaskensis G20 wild-type and the G20 tn5::rex mutant, distinct inhibition patterns were observed for the presumed competitive inhibitors of the sulfate reduction pathway and futile substrates of Sat. The susceptibility of pyruvate fermenting and sulfite reducing G20 to inorganic oxyanions provided further insights into the mechanism of action of selected compounds.

Of the compounds identified as selective inhibitors of sulfide production in the screen described herein, other considerations limit their worth as possible industrial treatments. Selenate, selenite, tellurate, and tellurite are toxic to diverse microorganisms and their abiotic reactivity may prevent their penetration into sulfidogenic environments in the desired redox state. Molybdate and tungstate are essential nutrients for many SRM,⁴⁶ are reactive with metals and sulfides in the environment, and are toxic to aquatic organisms.₄₇ This study is the first observation of vanadate as an SRM selective compound. Vanadium porphyrins and other transition metals have been observed in oil reservoirs.₄₈ It is unknown the extent to which transition metal oxyanions may be present in oil reservoirs and control sulfidogenesis.

Mechanistic Insights into MFP Inhibition

Taken together, the results support a model for MFP as a competitive substrate for the sulfate reduction pathway and as a vehicle for F⁻ delivery to the cytoplasm of actively sulfate respiring cells. Monofluorophosphate is isoelectronic with SO₄²⁻ and is a competitive inhibitor of sulfate respiration, but also noncompetitive at higher concentrations.³ MFP is a futile substrate of eukaryotic ATP sulfurylases that forms a relatively stable product.¹⁶ In the experiments described herein, MFP is a selective inhibitor of SRM in marine enrichment cultures, and the susceptibility of tn5::rex mutants and resistance of sulfite grown G20 to MFP suggest that it targets the initial steps of sulfate reduction. In support of a noncompetitive inhibition mechanism, MFP inhibition of Desulfovibrio alaskensis G20 was partially alleviated by fluoride efflux pumping suggesting that intracellular fluoride accumulation is associated with MFP toxicity. Fluoride is a potent inhibitor of microorganisms, largely due to its competition with catalytic hydroxide ions in enzyme active sites (e.g., enolase),^{49,50} but the IC₅₀ of F⁻ against D. alaskensis G20 is 50 times higher than MFP suggesting that its potency is offset by active efflux from the cell.

Considering MFP As an Inhibitor of Sulfate Reduction in Natural Microcosms and Engineered Ecosystems

MFP is a more potent inhibitor of sulfidogenesis in the marine enrichments (IC₅₀=1.9 (0.29-4.4) mM) than nitrate or (per)chlorate, and while nitrite and chlorite are similarly inhibitory, MFP is more selective than any of the nitrogen or chlorine oxyanions (FIG. 4). Furthermore, MFP is tolerated by NRM and PRM and is a synergistic inhibitor of sulfidogenesis in combination with nitrite and chlorite, which may increase the selectivity of the inhibitors (FIG. 6). Inappropriate dosing can lead to elimination of alternative microbial populations, drive the evolution of microbial resistance and could lead to a greater corrosion risk if the inhibitor is capable of driving microbially influenced corrosion (e.g., nitrate).^{?}

MFP has been demonstrated to be an effective inhibitor of abiotic corrosion of steel in concrete, although this could be largely due to passivization by phosphate ions after fluoride hydrolysis.^{51,52} At extremes of alkaline and acidic pH, MFP is unstable, but is stable for months at neutral pH.⁵³ Bacterial and eukaryotic alkaline phosphatases can hydrolyze fluorophosphate bonds,⁵⁴ but fluorophosphate is stable in the presence of other enzymes, such as acid phosphatase.⁵³ Also, pyruvate kinase has been demonstrated to possess fluorokinase activity, synthesizing FPO₃²⁻ from F⁻ and PO₄²⁻.⁵⁵ The assimilatory ATP sulfurylases are inhibited by MFP.¹⁶ Thus, in microbial ecosystems where sulfate is the primary sulfur source, addition of more labile forms of sulfur (e.g., cysteine) could be considered as additional amendments during SRM specific inhibitor treatments to help ensure selectivity for dissimilatory SRM versus organisms relying on sulfate assimilation to obtain sulfur. Dicationic MFP salts (e.g., calcium MFP, ferrous MFP) are more soluble than the corresponding phosphate salts, and are more similar to phosphite (PO₃²⁻) salts. The solubility constant for calcium MFP is ˜30 mM, thus SRM inhibitory concentrations of soluble MFP should be deliverable to environments with high concentrations of divalent cations.⁵⁶ The results presented herein establish MFP as a promising alternative to conventional strategies for inhibition of sulfate reduction.

### Example 5

### Inhibition of Sulfate Reduction in Continuous Sediment Bioreactors Using Monofluorophosphate Dosing

This Example demonstrates that MFP is able to inhibit sulfate reduction in a bioreactor environment.

### Introduction

Hydrogen sulfide (H₂S) is produced by sulfate-reducing microorganisms in a wide range of environmental and industrial settings, including oil reservoirs. H₂S is toxic, explosive, corrosive, and a primary cause of pipeline leaks and explosions. Despite the economic costs of sulfidogenesis in oil recovery, inhibition of sulfate-reducing microorganisms (SRM) is poorly understood and challenging.

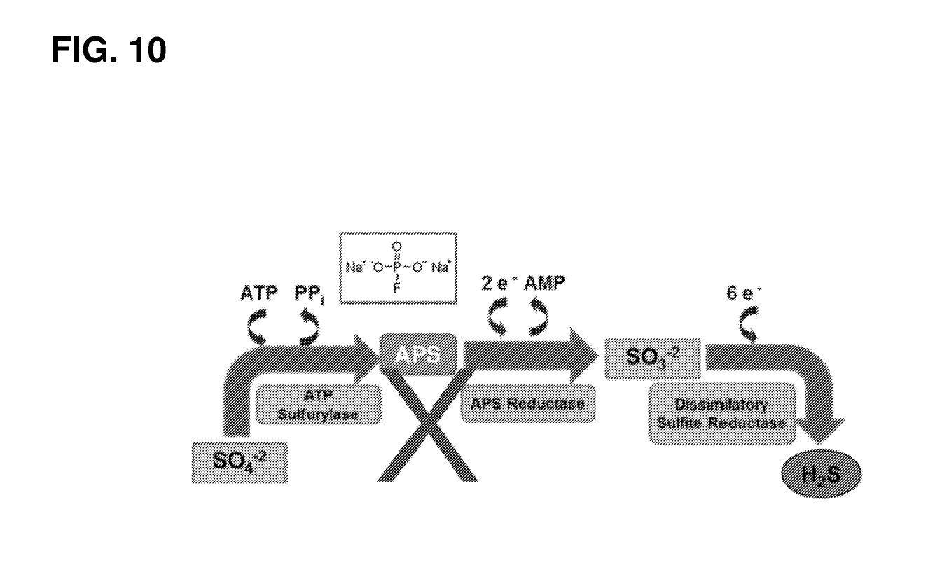

As described in the above Examples, Applicants have identified monofluorophosphate (MFP) as a practical, non-toxic and cost-effective sulfate-reduction inhibitor that could be widely considered for the control of sulfidogenesis in industrial ecosystems. A model of the inhibition of ATP sulfuryase is presented in FIG. 10. In this Example, Applicants constructed replicated systems to investigate the effect of MFP on sulfate reduction in mixed-species communities.

### Approach

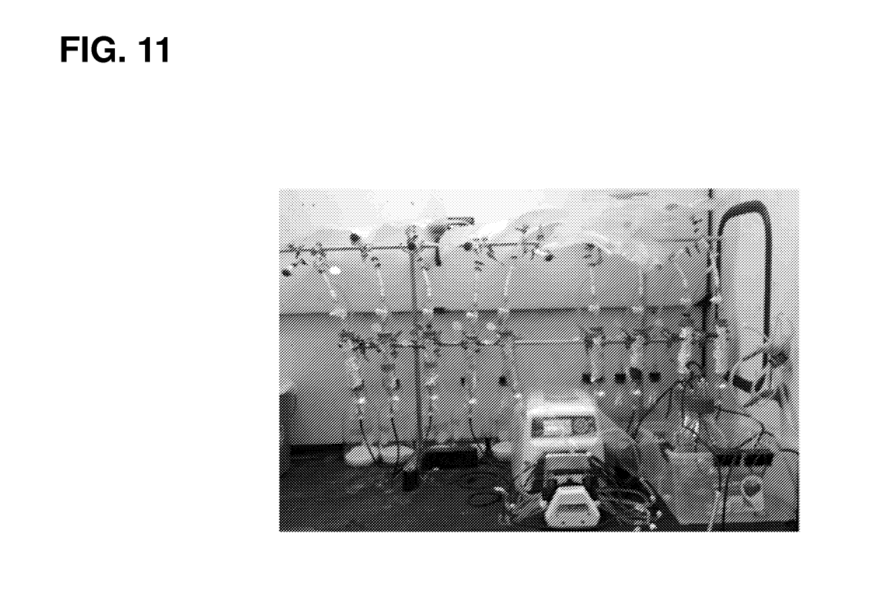

FIG. 11 illustrates the set-up of the replicated sediment bioreactors used in the experiments described herein. Replicated sediment bioreactors (R1-9) were constructed and continuously enriched on a marine medium containing sulfate and electron donors. The conditions for the replicated sediment bioreactors were as follows: carbon source was yeast extract, biomass: marine sediment, COD: 1.5 g/L, sulfate: 20 mM, retention time: 2 days. Parameters include: sulfate, sulfite, methane, Chemical Oxygen Demand, volatile fatty acids, fate of MFP, and community structure.

After completing souring and establishing sulfidogenic, mixed-species microbial communities in the bioreactors, sulfate was removed from R1-3 medium, while MFP was used to treat R7-9.

### Results

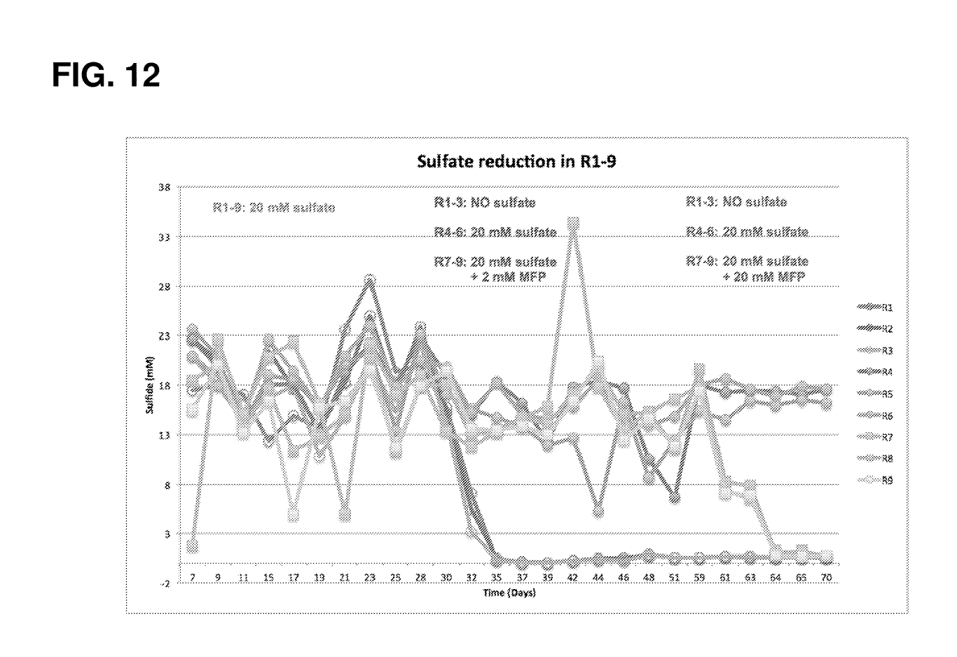

In the bioreactor setup in this Example, it was found that MFP dosing at 2 mM did not result in inhibition of sulfate reduction during the second dosing period, but dosing at 20 mM resulted in rapid inhibition of sulfate reduction during the third dosing period (FIG. 12).

### REFERENCES

(1) WHO. Hydrogen Sulfide. In WHO Regional Publications, European Series: Denmark, 2000; pp 1-7.
(2) Gieg, L. M.; Jack, T. R.; Foght, J. M. Biological souring and mitigation in oil reservoirs. Appl. Microbiol. Biotechnol. 2011, 92 (2), 263-282.
(3) Postgate, J. R. Competitive and noncompetitive inhibitors of bacterial sulphate reduction. J. Gen. Microbiol. 1952, 6 (1-2), 128-142.
(4) Greene, E. A.; Brunelle, V.; Jenneman, G. E.; Voordouw, G. Synergistic inhibition of microbial sulfide production by combinations of the metabolic inhibitor nitrite and biocides. Appl. Environ. Microbiol. 2006, 72 (12), 7897-901.
(5) Fink, J. K. Petroleum Engineer's Guide to Oil Field Chemicals and Fluids. Petroleum Engineer's Guide to Oil Field Chemicals and Fluids, 2012, 1-785.
(6) Youssef, N.; Elshahed, M. S.; McInerney, M. J. Microbial processes in oil fields: Culprits, problems, and opportunities. Adv. Appl. Microbiol. 2008, 66, 141-251.
(7) Hubert, C., Microbial ecology of oil reservoir souring and its control by nitrate injection. In Handbook of Hydrocarbon and Lipid Microbiology; Springer: New York, 2010; pp 2753-2766.
(8) Greene, E. A.; Hubert, C.; Nemati, M.; Jenneman, G. E.; Voordouw, G. Nitrite reductase activity of sulphate-reducing bacteria prevents their inhibition by nitrate-reducing, sulphide-oxidizing bacteria. Environ. Microbiol. 2003, 5 (7), 607-617.
(9) Sorensen, J.; Tiedje, J. M.; Firestone, R. B. Inhibition by sulfide of nitric and nitrous oxide reduction by denitrifying Pseudomonas fluorescens. Appl. Environ. Microbiol. 1980, 39 (1), 105-8.
(10) Zhou, J.; He, Q.; Hemme, C. L.; Mukhopadhyay, A.; Hillesland, K.; Zhou, A.; He, Z.; Van Nostrand, J. D.; Hazen, T. C.; Stahl, D. A.; Wall, J. D.; Arkin, A. P. How sulphate-reducing microorganisms cope with stress: lessons from systems biology. Nat. Rev. Microbiol. 2011, 9 (6), 452-466.
(11) Carlson, H. K.; Kuehl, J. V.; Hazra, A. B.; Justice, N. B.; Stoeva, M. K.; Sczesnak, A.; Mullan, M. R.; lavarone, A. T.; Engelbrektson, A.; Price, M. N.; Deutschbauer, A. M.; Arkin, A. P.; Coates, J. D. Mechanisms of direct inhibition of the respiratory sulfate-reduction pathway by (per)chlorate and nitrate. ISME J. 2014, DOI: 10.1038/ismej.2014.216.
(12) Engelbrektson, A.; Hubbard, C. G.; Tom, L. M.; Boussina, A.; Jin, Y. T.; Wong, H.; Piceno, Y. M.; Carlson, H. K.; Conrad, M. E.; Anderson, G.; Coates, J. D. Inhibition of microbial sulfate reduction in a flow-through column system by (per)chlorate treatment. Front. Microbiol. 2014, 5, 315.
(13) Gregoire, P.; Engelbrektson, A.; Hubbard, C. G.; Metlagel, Z.; Csencsits, R.; Auer, M.; Conrad, M. E.; Thieme, J.; Northrup, P.; Coates, J. D. Control of sulfidogenesis through bio-oxidation of H2S coupled to (per)chlorate reduction. Environ. Microbiol. Rep. 2014, 6 (6), 558-564.
(14) Hanna, E.; MacRae, I. J.; Medina, D. C.; Fisher, A. J.; Segel, I. H. ATP sulfurylase from the hyperthermophilic chemolithotroph Aquifex aeolicus. Arch. Biochem. Biophys. 2002, 406 (2), 275-288.
(15) Renosto, F.; Patel, H. C.; Martin, R. L.; Thomassian, C.; Zimmerman, G.; Segel, I. H. Atp sulfurylase from higher plants: Kinetic and structural characterization of the chloroplast and cytosol enzymes from spinach Leaf. Arch. Biochem. Biophys. 1993, 307 (2), 272-285.
(16) Hanna, E.; Ng, K. F.; MacRae, I. J.; Bley, C. J.; Fisher, A. J.; Segel, I. H. Kinetic and stability properties of Penicillium chrysogenum ATP sulfurylase missing the C-terminal regulatory domain. J. Biol. Chem. 2004, 279 (6), 4415-4424.
(17) Peck, H. D. The ATP-dependent reduction of sulfate with hydrogen in extracts of Desulfovibrio desulfuricans. Proc. Natl. Acad. Sci. U. S. A. 1959, 45 (5), 701-708.
(18) Peck, H. D. The role of adenosine-5′-phosphosulfate in the reduction of sulfate to sulfite by Desulfovibrio desulfuricans. J. Biol. Chem. 1962, 237, 198-203.
(19) Cypionka, H. Characterization of sulfate transport in Desulfovibrio desulfuricans. Arch. Microbiol. 1989, 152 (3), 237-243.
(20) Taylor, B. F.; Oremland, R. S. Depletion of adenosine- triphosphate in Desulfovibrio by oxyanions of Group-VI elements. Curr. Microbiol. 1979, 3 (2), 101-103.
(21) Oremland, R. S.; Taylor, B. F. Sulfate reduction and methanogenesis in marine sediments. Geochim. Cosmochim. Acta 1978, 42 (2), 209-214.
(22) Satishchandran, C.; Myers, C. B.; Markham, G. D. Adenosine-5′-O-(2 fluorodiphosphate) (ADP-beta-F), an analog of adenosine-5′-phosphosulfate. Bioorg. Chem. 1992, 20 (2), 107-114.
(23) Price, M. N.; Deutschbauer, A. M.; Skerker, J. M.; Wetmore, K. M.; Ruths, T.; Mar, J. S.; Kuehl, J. V.; Shao, W.; Arkin, A. P. Indirect and suboptimal control of gene expression is widespread in bacteria. Mol. Syst. Biol. 2013, 9, 660.
(24) Mukhopadhyay, A.; He, Z.; Alm, E. J.; Arkin, A. P.; Baidoo, E. E.; Borglin, S. C.; Chen, W.; Hazen, T. C.; He, Q.; Holman, H. Y.; Huang, K.; Huang, R.; Joyner, D. C.; Katz, N.; Keller, M.; Oeller, P.; Redding, A.; Sun, J.; Wall, J.; Wei, J.; Yang, Z.; Yen, H. C.; Zhou, J.; Keasling, J. D. Salt stress in Desulfovibrio vulgaris Hildenborough: an integrated genomics approach. J. Bacteriol. 2006, 188 (11), 4068-78.
(25) European Committee for Antimicrobial Susceptibility Testing of the European Society of Clinical, M.; Infectious, D., EUCAST Definitive Document E.Def 1.2, May 2000: Terminology relating to methods for the determination of susceptibility of bacteria to antimicrobial agents. Clin. Microbiol. Infect. 2000, 6 (9), 503-508.
(26) Kozich, J. J.; Westcott, S. L.; Baxter, N. T.; Highlander, S. K.; Schloss, P. D. Development of a dual-index sequencing strategy and curation pipeline for analyzing amplicon sequence data on the MiSeq Illumina sequencing platform. Appl. Environ. Microbiol. 2013, 79 (17), 5112-5120.
(27) Fadrosh, D. W.; Ma, B.; Gajer, P.; Sengamalay, N.; Ott, S.; Brotman, R. M.; Ravel, J. An improved dual-indexing approach for multiplexed 16S rRNA gene sequencing on the Illumina MiSeq platform. Microbiome 2014, 2 (1), 6.
(28) Zhang, J.; Kobert, K.; Flouri, T.; Stamatakis, A. A fast and accurate illumina paired-end read merge RPEAR. Bioinformatics 2014, 30 (5), 614-620.
(29) Caporaso, J. G.; Kuczynski, J.; Stombaugh, J.; Bittinger, K.; Bushman, F. D.; Costello, E. K.; Fierer, N.; Pena, A. G.; Goodrich, J. K.; Gordon, J. I.; Huttley, G. A.; Kelley, S. T.; Knights, D.; Koenig, J. E.; Ley, R. E.; Lozupone, C. A.; McDonald, D.; Muegge, B. D.; Pirrung, M.; Reeder, J.; Sevinsky, J. R.; Turnbaugh, P. J.; Walters, W. A.; Widmann, J.; Yatsunenko, T.; Zaneveld, J.; Knight, R. QIIME allows analysis of high-throughput community sequencing data. Nat. Methods 2010, 7 (5), 335-336.
(30) Bourne, D. G.; Muirhead, A.; Sato, Y. Changes in sulfate-reducing bacterial populations during the onset of black band disease. ISME J. 2011, 5 (3), 559-564.
(31) Leloup, J.; Loy, A.; Knab, N. J.; Borowski, C.; Wagner, M.;Jorgensen, B. B. Diversity and abundance of sulfate-reducing microorganisms in the sulfate and methane zones of a marine sediment, Black Sea. Environ. Microbiol. 2007, 9 (1), 131-142.
(32) Tor, J. M.; Amend, J. P.; Lovley, D. R. Metabolism of organic compounds in anaerobic, hydrothermal sulphate-reducing marine sediments. Environ. Microbiol. 2003, 5 (7), 583-591.
(33) Tucker, M. D.; Barton, L. L.; Thomson, B. M. Reduction of Cr, Mo, Se and U by Desulfovibrio desulfuricans immobilized in polyacrylamide gels. J. Ind. Microbiol. Biot. 1998, 20 (1), 13-19.
(34) Zehr, J. P.; Oremland, R. S. Reduction of selenate to selenide by sulfate-respiring bacteria: experiments with cell suspensions and estuarine sediments. Appl. Environ. Microbiol. 1987, 53 (6), 1365-1369.
(35) Achenbach, L. A.; Michaelidou, U.; Bruce, R. A.; Fryman, J.; Coates, J. D. Dechloromonas agitata gen. nov., sp. nov. and Dechlorosoma suillum gen. nov., sp. nov., two novel environmentally dominant (per)chlorate-reducing bacteria and their phylogenetic position. Int. J. Syst. Evol. Microbiol. 2001, 51 (Pt 2), 527-533.
(36) Lehar, J.; Krueger, A. S.; Avery, W.; Heilbut, A. M.; Johansen, L. M.; Price, E. R.; Rickles, R. J.; Short, G. F., 3rd; Staunton, J. E.; Jin, X.; Lee, M. S.; Zimmermann, G. R.; Borisy, A. A. Synergistic drug combinations tend to improve therapeutically relevant selectivity. Nat. Biotechnol. 2009, 27 (7), 659-666.
(37) Kuehl, J. V.; Price, M. N.; Ray, J.; Wetmore, K. M.; Esquivel, Z.; Kazakov, A. E.; Nguyen, M.; Kuehn, R.; Davis, R. W.; Hazen, T. C.; Arkin, A. P.; Deutschbauer, A. Functional genomics with a comprehensive library of transposon mutants for the sulfate-reducing bacterium Desulfovibrio alaskensis G20. mBio 2014, 5 (3), e01041-e01114.
(38) Korte, H. L.; Fels, S. R.; Christensen, G. A.; Price, M. N.; Kuehl, J. V.; Zane, G. M.; Deutschbauer, A. M.; Arkin, A. P.; Wall, J. D. Genetic basis for nitrate resistance in Desulfovibrio strains. Front. Microbiol. 2014, 5, 153.
(39) Li, X.; Krumholz, L. R. Regulation of arsenate resistance in Desulfovibrio desulfuricans G20 by an arsRBCC operon and an arsC gene. J. Bacteriol. 2007, 189 (10), 3705-3711.
(40) Wolfe, B. M.; Lui, S. M.; Cowan, J. A. Desulfoviridin, a multimeric-dissimilatory sulfite reductase from Desulfovibrio vulgaris (Hildenborough). Purification, characterization, kinetics and EPR studies. Eur. J. Biochem. 1994, 223 (1), 79-89.
(41) Meyer, B.; Kuehl, J. V.; Price, M. N.; Ray, J.; Deutschbauer, A. M.; Arkin, A. P.; Stahl, D. A. The energy-conserving electron transfer system used by Desulfovibrio alaskensis strain G20 during pyruvate fermentation involves reduction of endogenously formed fumarate and cytoplasmic and membrane-bound complexes, Hdr-Flox and Rnf. Environ. Microbiol. 2014, 16 (11), 3463-3486.
(42) Lie, T. J.; Godchaux, W.; Leadbetter, E. R. Sulfonates as terminal electron acceptors for growth of sulfite-reducing bacteria (Desulfitobacterium spp.) and sulfate-reducing bacteria: effects of inhibitors of sulfidogenesis. Appl. Environ. Microbiol. 1999, 65 (10), 4611-4617.
(43) Yurkiw, M. A.; Voordouw, J.; Voordouw, G. Contribution of rubredoxin:oxygen oxidoreductases and hybrid cluster proteins of Desulfovibrio vulgaris Hildenborough to survival under oxygen and nitrite stress. Environ. Microbiol. 2012, 14 (10), 2711-2725.
(44) Breaker, R. R. New insight on the response of bacteria to fluoride. Caries Res. 2012, 46 (1), 78-81.
(45) Baker, J. L.; Sudarsan, N.; Weinberg, Z.; Roth, A.; Stockbridge, R. B.; Breaker, R. R. Widespread genetic switches and toxicity resistance proteins for fluoride. Science 2012, 335 (6065), 233-235.
(46) Mota, C. S.; Valette, 0.; Gonzalez, P. J.; Brondino, C. D.; Moura, J. J.; Moura, I.; Dolla, A.; Rivas, M. G. Effects of molybdate and tungstate on expression levels and biochemical characteristics of formate dehydrogenases produced by Desulfovibrio alaskensis NCIMB 13491. J. Bacteriol. 2011, 193 (12), 2917-2923.
(47) Heijerick, D. G.; Regoli, L.; Carey, S. The toxicity of molybdate to freshwater and marine organisms. II. Effects assessment of molybdate in the aquatic environment under REACH. Sci. Total Environ. 2012, 435-436, 179-187.
(48) Treibs, A. On the occurrence of chlorophyll-derivatives in an oil- slate in the upper trias. Liebigs Ann. Chem. 1934, 509, 103-114.
(49) Hoorn, R. K. J.; Flikweert, J. P.; Staal, G. E. J. Purification and properties of enolase of human erythrocytes. Int. J. Biochem. 1974, 5 (11-12), 845-852.
(50) Qin, R.; Chai, G. Q.; Brewer, J. M.; Lovelace, L. L.; Lebioda, L. Fluoride inhibition of enolase: Crystal structure and thermodynamics. Biochemistry-U.S. 2006, 45 (3), 793-800.
(51) Ngala, V. T.; Page, C. L.; Page, M. M. Corrosion inhibitor systems for remedial treatment of reinforced concrete. Part 2: Sodium monofluorophosphate. Corros. Sci. 2003, 45 (7), 1523-1537.
(52) Soylev, T. A.; Richardson, M. G. Corrosion inhibitors for steel in concrete: State-of-the-art report. Constr. Build. Mater. 2008, 22 (4), 609-622.
(53) Setnikar, I.; Arigoni, R. Chemical stability and mode of gastrointestinal absorption of sodium monofluorophosphate. Arznei- mittelforschung 1988, 38 (1), 45-49.
(54) Fernley, H. N.; Walker, P. G. Studies on alkaline phosphatase. Inhibition by phosphate derivatives and the substrate specificity. Biochem. J. 1967, 104 (3), 1011-1018.
(55) Tietz, A.; Ochoa, S. Fluorokinase and pyruvic kinase. Arch. Biochem. Biophys. 1958, 78 (2), 477-493.
(56) Rowley, H. H.; Stuckey, J. E. Preparation and properties of calcium monofluorophosphate dihydrate. J. Am. Chem. Soc. 1956, 78 (17), 4262-4263.
Youssef N, Elshahed M S, McInerney M J. 2008. Microbial Processes in Oil Fields: Culprits, Problems, and Opportunities. Advances in applied microbiology 66:141-251.
Vance I, Thrasher D R. 2005. Reservoir souring: mechanisms and prevention. In Ollivier B, Magot M (ed.), Petroleum Microbiology. ASM Press, Washington, D.C.
Aeckersberg F, Bak F, Widdel F. 1991. Anaerobic oxidation of saturated hydrocarbons to CO₂ by a new type of sulfate-reducing bacterium. Arch Microbial. 156:5-14.
Anderson R T, Lovley D R. 2000. Anaerobic bioremediation of benzene under sulfate-reducing conditions in a petroleum-contaminated aquifer. Environ. Sci. Technol. 34:2261-2266.
Annweiler E, Materna A, Safinowski M, Kappler A, Richnow H, Michaelis W, Meckenstock R. 2000. Anaerobic degradation of 2-methylnaphthalene by a sulfate-reducing enrichment culture. Applied and Environmental Microbiology 66:5329.
Bedessem ME, Swoboda-Colberg NG, Colberg PJS. 1997. Naphthalene mineralization coupled to sulfate reduction in aquifer-derived enrichments. FEMS Microbiology Letters 152:213-218.
Beller H R, Grbic-Galic D, Reinhard M. 1992. Microbial degradation of toluene under sulfate-reducing conditions and the influence of iron on the process. Appl. Environ. Microbial. 58:786 793.
Beller H R, Spormann A M, Sharma P K, Cole J R, Reinhard M. 1996. Isolation and characterization of a novel toluene-degrading, sulfate-reducing bacterium. Applied and Environmental Microbiology 62:1188-1196.
Caldwell M E, Garrett R M, Prince R C, Suflita J M. 1998. Anaerobic biodegradation of long-chain n-alkanes under sulfate-reducing conditions. Environmental Science & Technology37:2191-2195.
Coates J D, Anderson R T, Lovley D R. 1996. Anaerobic oxidation of polycyclic aromatic hydrocarbons under sulphate-reducing conditions. Applied and Environmental Microbiology 62:1099-1101.
Coates J D, Anderson R T, Lovley D R. 1996. Anaerobic hydrocarbon degradation in petroleum-contaminated harbor sediments under sulfate-reducing and artificially imposed iron-reducing conditions. Environmental Science and Technology 30:2784-2789.
Coates J D, Woodward J, Allen J, Philp P, Lovley D R. 1997. Anaerobic degradation of polycyclic aromatic hydrocarbons and alkanes in petroleum contaminated marine harbor sediments. Appl. Environ. Microbiol. 63:3589-3593.
Edwards E A, Wills L E, Reinhard M, Grbic-Galic D. 1992. Anaerobic degradation of toluene and xylene by aquifer microorganisms under sulfate reducing conditions. Appl. Environ. Microbial. 58:794-800.
Galushko A, Minz D, Schink B, Widdel F. 1999. Anaerobic degradation of naphthalene by a pure culture of a novel type of marine sulfate-reducing bacterium. Environ Microbiol 1:1-23.
Laban N, Selesi D, Jobelius C, Meckenstock R. 2009. Anaerobic benzene degradation by Gram-positive sulfate-reducing bacteria. FEMS Microbiology Ecology 68:300-311.
Lovley D R, Coates J D, Woodward J C, Phillips E J P. 1995. Benzene oxidation coupled to sulfate reduction. Appl. Environ. Microbiol. 61:953-958.
Widdel F, Bak F. 1992. Gram-negative mesophilic sulfate-reducing bacteria, p. 3353-3378. In Balows A, Truper H G, Dworkin M, Harder W, Schleifer K-H (ed.), The Prokaryotes, vol. 4. Springer-Verlag, N.Y.
Larsen J. 2002. Corrosion 2002, Houston Tex.
Cummins D. 2013. The development and validation of a new technology, based upon 1.5% arginine, an insoluble calcium compound and fluoride, for everyday use in the prevention and treatment of dental caries. Journal of Dentistry 41:S1-S11.
Postgate J R. 1952. Competitive and non-competitive inhibitors of bacterial sulphate reduction. Microbiology (Reading, England) 6:128-142.
Xu Q, Townsend T, & Bitton G (2011) Inhibition of hydrogen sulfide generation from disposed gypsum drywall using chemical inhibitors. Journal of hazardous materials 191(1-3):204-211.
Patidar S K & Tare V (2005) Effect of molybdate on methanogenic and sulfidogenic activity of biomass. Bioresource technology 96(11):1215-1222.
Biswas K C, Woodards N A, Xu H, & Barton LL (2009) Reduction of molybdate by sulfate-reducing bacteria. Biometals: an international journal on the role of metal ions in biology, biochemistry, and medicine 22(1): 131-139.
Chen G, Ford T E, & Clayton C R (1998) Interaction of Sulfate-Reducing Bacteria with Molybdenum Dissolved from Sputter-Deposited Molybdenum Thin Films and Pure Molybdenum Powder. Journal of colloid and interface science 204(2):237-246.

What is claimed is:

1. A method for controlling souring comprising contacting an engineered system comprising a souring-promoting microbial community with a composition comprising monofluorophosphate at a concentration sufficient to inhibit souring in a unit volume of the engineered system.

2. The method of claim 1, wherein the engineered system is an oil reservoir.

3. The method of any one of claim 1 or 2, wherein the composition comprising monofluorophosphate is an aqueous solution of a salt of monofluorophosphate.

4. The method of claim 3, wherein the salt of monofluorophosphate is selected from the group consisting of sodium salts, ammonium salts, potassium salts, and calcium salts of monofluorophosphate.

5. The method of any one of claims 1-4, wherein the concentration of the monofluorophosphate present in the engineered system is in the range of about 0.1 mM to about 5 mM.

6. The method of claim 5, wherein the concentration of the monofluorophosphate present in the engineered system is about 0.8 mM.

7. The method of any one of claims 1-6, wherein the microbial community comprises both sulfate-reducing microorganisms and non-sulfate-reducing microorganisms.

8. The method of claim 7, wherein the monofluorophosphate in the engineered system does not significantly impact the general metabolism of the non-sulfate-reducing microorganisms.

9. The method of any one of claims 1-8, wherein souring in a unit volume of the engineered system is inhibited by about 50% or more as compared to a corresponding unit volume in a system not contacted with monofluorophosphate.

10. The method of claim 9, wherein souring is assayed by measuring parameters selected from the group consisting of hydrogen sulfide production, fluid contamination, metal corrosion, and clogging of the engineered system.

11. The method of any one of claims 1-10, wherein the method further comprises contacting the engineered system with a second composition comprising an additional souring inhibitor.

12. The method of claim 11, wherein the second composition comprises nitrate or (per)chlorate.

13. A method for controlling souring comprising contacting an engineered system comprising a souring-promoting microbial community with a heated fluid at a temperature sufficient to inhibit souring in a unit volume of the engineered system.

14. The method of claim 13, wherein the engineered system is an oil reservoir.

15. The method of any one of claim 13 or 14, wherein the temperature of the heated fluid present in the engineered system is at least about 60° C.

16. The method of claim 15, wherein the temperature of the heated fluid present in the engineered system is about 125° C. or more.

17. The method of any one of claims 13-16, wherein the heated fluid comprises seawater.

18. The method of any one of claims 13-17, wherein souring in a unit volume of the engineered system is inhibited by about 50% or more as compared to a corresponding unit volume in a system not contacted with the heated fluid.

19. The method of claim 18, wherein souring is assayed by measuring parameters selected from the group consisting of hydrogen sulfide production, fluid contamination, metal corrosion, and clogging of the engineered system.

20. The method of any one of claims 13-19, wherein the unit volume comprises at least 90% of the total volume of the engineered system.

21. The method of any one of claims 13-20, wherein the method further comprises contacting the engineered system with a composition comprising a souring inhibitor.

22. The method of claim 21, wherein the composition comprises a compound selected from the group consisting of monofluorophosphate, nitrate, and (per)chlorate.

23. A method for controlling souring comprising contacting an engineered system comprising a souring-promoting microbial community with:
a composition comprising a souring inhibitor, and;
a heated fluid,
wherein the concentration of the souring inhibitor and the temperature of the heated fluid are sufficient to inhibit souring in a unit volume of the engineered system.

24. The method of claim 23, wherein the engineered system is an oil reservoir.

25. The method of any one of claim 23 or 24, wherein the souring inhibitor is selected from the group consisting of monofluorophosphate, nitrate, and (per)chlorate.

26. The method of claim 25, wherein the souring inhibitor is monofluorophosphate and wherein the concentration of the monofluorophosphate present in the engineered system is in the range of about 0.1 mM to about 5 mM.

27. The method of any one of claims 23-26, wherein the temperature of the heated fluid present in the engineered system is about 60° C. or more.

28. The method of claim 27, wherein the heated fluid comprises seawater.

29. The method of any one of claims 23-28, wherein souring in a unit volume of the engineered system is inhibited by about 50% or more as compared to a corresponding unit volume in a system not contacted with the inhibitor of souring or the heated fluid.

30. The method of claim 29, wherein souring is assayed by measuring parameters selected from the group consisting of hydrogen sulfide production, fluid contamination, metal corrosion, and clogging of the engineered system.

31. A method for controlling souring comprising contacting an engineered system comprising a souring-promoting microbial community with a cooled fluid at a temperature sufficient to inhibit souring in a unit volume of the engineered system.

32. The method of claim 31, wherein the engineered system is an oil reservoir.

33. The method of any one of claim 31 or 32, wherein the temperature of the cooled fluid present in the engineered system is below 0° C.

34. The method of any one of claims 31-33, wherein the cooled fluid comprises seawater.

35. The method of any one of claims 31-34, wherein souring in a unit volume of the engineered system is inhibited by about 50% or more as compared to a corresponding unit volume in a system not contacted with the cooled fluid.

36. The method of claim 35, wherein souring is assayed by measuring parameters selected from the group consisting of hydrogen sulfide production, fluid contamination, metal corrosion, and clogging of the engineered system.

37. The method of any one of claims 31-36, wherein the unit volume comprises at least 90% of the total volume of the engineered system.

38. The method of any one of claims 31-37, wherein the method further comprises contacting the engineered system with a composition comprising a souring inhibitor.

39. The method of claim 38, wherein the composition comprises a compound selected from the group consisting of monofluorophosphate, nitrate, and (per)chlorate.

40. A method for controlling souring comprising contacting an engineered system comprising a souring-promoting microbial community with:
a composition comprising a souring inhibitor, and;
a cooled fluid,
wherein the concentration of the souring inhibitor and the temperature of the cooled fluid are sufficient to inhibit souring in a unit volume of the engineered system.

41. The method of claim 40, wherein the engineered system is an oil reservoir.

42. The method of any one of claim 40 or 41, wherein the souring inhibitor is selected from the group consisting of monofluorophosphate, nitrate, and (per)chlorate.

43. The method of claim 42, wherein the souring inhibitor is monofluorophosphate and wherein the concentration of the monofluorophosphate present in the engineered system is in the range of about 0.1 mM to about 5 mM.

44. The method of any one of claims 40-43, wherein the temperature of the cooled fluid present in the engineered system is below 0° C.

45. The method of claim 44, wherein the cooled fluid comprises seawater.

46. The method of any one of claims 40-45, wherein souring in a unit volume of the engineered system is inhibited by about 50% or more as compared to a corresponding unit volume in a system not contacted with the inhibitor of souring or the cooled fluid.

47. The method of claim 46, wherein souring is assayed by measuring parameters selected from the group consisting of hydrogen sulfide production, fluid contamination, metal corrosion, and clogging of the engineered system.
